(19) United States
(12) Patent Application Publication
(10) Pub. No.: US 2024/0362818 A1
(43) Pub. Date: Oct. 31, 2024

(54) METHOD AND DEVICE WITH DETERMINING POSE OF TARGET OBJECT IN QUERY IMAGE

(71) Applicant: Samsung Electronics Co., Ltd., Suwon-si (KR)

(72) Inventors: Jingrui SONG, Beijing (CN); Weiming LI, Beijing (CN); Qiang WANG, Beijing (CN); Soonyong CHO, Suwon-si (KR); Xiaoxuan YU, Beijing (CN); SUNG YOUNG HUN, Suwon-si (KR)

(73) Assignee: Samsung Electronics Co., Ltd., Suwon-si (KR)

(21) Appl. No.: 18/648,212

(22) Filed: Apr. 26, 2024

(30) Foreign Application Priority Data
Apr. 28, 2023 (CN) 202310485584.5
Feb. 8, 2024 (CN) 202410178298.9
Mar. 5, 2024 (KR) 10-2024-0031355

(51) Int. Cl. G06T 7/73

(52) U.S. Cl. CPC G06T 7/73

(57) ABSTRACT

A method of determining a pose of a target object in a query image may include: obtaining a query image; obtaining a plurality of reference images corresponding to the query image; and determining a pose of a target object based on a first semantic feature corresponding to the query image and a second semantic feature corresponding to each of the plurality of reference images.

### CROSS-REFERENCE TO RELATED APPLICATIONS

This application claims the benefit under 35 USC § 119 (a) of Chinese Patent Application No. 202310485584.5 filed on Apr. 28, 2023, and Chinese Patent Application No. 202410178298.9 filed on Feb. 8, 2024, in the China National Intellectual Property Administration, and Korean Patent Application No. 10-2024-0031355 filed on Mar. 5, 2024, in the Korean Intellectual Property Office, the entire disclosures of which are incorporated herein by reference for all purposes.

### BACKGROUND

### 1. Field

The following description relates to a computer technology field and, more particularly, to a method and an electronic device for determining a pose of a target object in a query image.

### 2. Description of Related Art

Technology for estimating the pose of an object in an image may use a pose estimation algorithm to process red, green, and blue (RGB) information (e.g., a color image) and depth information (e.g., a depth image) obtained by sensors and thereby estimate (or determine) the pose of an object in an image. A pose of an object has wide applicability to many technical fields, for example, augmented reality (AR), virtual reality (VR), robotics, autonomous/assisted driving or the like. Accurate estimates of poses of objects may provide users with high-quality virtual display effects or allow robots to manipulate objects more accurately using the estimated poses of the objects.

Currently, there is ongoing research on various pose estimation methods using artificial intelligence (AI) models.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a method performed by an electronic device includes: obtaining a query image; obtaining reference images corresponding to the query image, wherein the reference images are obtained based on having respective reference objects therein that have a same object type as an object type of an object in the query image; determining a first semantic feature and first information corresponding to the query image, wherein the first information includes first geometric information of the query image or first positional information of the query image; determining second semantic features and second pieces of information of the respectively corresponding reference images, wherein the second pieces of information include second geometric information or second positional information of their respectively corresponding reference images, each reference image having a corresponding second semantic feature and second piece of information; and determining a pose of the target object based on (i) the first semantic feature and the first information and (ii) the second semantic features and the second pieces of information.

The determining of the pose of the target object may include: generating a first association feature of the query image based on the first semantic feature and the first geometric information of the query image; generating a second association feature of the query image based on the second semantic features and the second pieces of geometric information of the reference images; and determining the pose of the target object based on the first association feature and the second association feature.

The obtaining of the reference images corresponding to the query image may include: based on determining that the target object in the query image is an object registered in a database, obtaining the reference images from the database.

The determining of the pose of the target object based on the first association feature and the second association feature may include: generating correlation matrixes of correlation between the query image and each of the respectively corresponding reference images based on the first association feature and the second association feature, wherein each correlation matrix may represent a relative position of a first pixel block of the query image with respect to a positionally-corresponding second pixel block of its corresponding reference image; and determining the pose of the target object based on the correlation matrixes.

The generating of one of the correlation matrixes may include: inputting the first association feature and the second association feature corresponding to the one of the correlation matrixes into an attention network.

The attention network may include a first attention module, the first attention module may include two first self-attention units connected in parallel, a first cross-attention unit, and two second self-attention units connected in parallel, and the generating of the correlation matrixes may include: generating a first self-correlation feature of the query image and a second self-correlation feature of each of the reference images by inputting the first association feature and the second association feature into the first self-attention units, respectively; generating a first cross-correlation feature of the query image and a second cross-correlation feature of each of the reference images by inputting the first self-correlation feature and the second self-correlation feature into the first cross-attention unit; generating a third self-correlation feature of the query image and a fourth self-correlation feature of each of the reference images by inputting the first cross-correlation feature and the second cross-correlation feature into the second self-attention units, respectively; and generating the correlation matrix between the query image and each of the reference images based on the third self-correlation feature and the fourth self-correlation feature.

The attention network may further include one or more second attention modules, each of the one or more second attention modules may include a second cross-attention unit and two third self-attention units connected in parallel, an input of a second attention module may be a self-correlation feature generated by a previous second attention module, and a self-correlation feature generated by the second attention module may be used as an input to a next second attention module, and the generating of the correlation matrix between the query image and each of the reference images may include: generating the correlation matrixes between the query image and the respective reference images based on a self-correlation feature generated by a last second attention module.

The generating of the first self-correlation feature of the query image and the second self-correlation feature of each of the reference images by inputting the first association feature and the second association feature into the first self-attention units may include: generating a first feature vector by stitching feature vectors respectively corresponding to pixel blocks of the first association feature; generating a first semantic slot sequence corresponding to the first feature vector; generating a second semantic slot sequence by applying a self-attention mechanism to the first semantic slot sequence; and generating the first self-correlation feature based on the second semantic slot sequence and the first feature vector.

The generating of the first self-correlation feature based on the second semantic slot sequence and the first feature vector may include: for each semantic slot of the second semantic slot sequence, generating a processed semantic slot by expanding a semantic slot into the same number of pixel blocks as the first association feature; generating a semantic slot feature vector having the same feature dimension as the first feature vector by decoding the processed semantic slot based on positional information; generating a second feature vector by fusing feature vectors of pixel blocks at the same position among semantic slot feature vectors; generating a fused feature vector by fusing the first feature vector and a feature vector of a pixel block at the same position in the second feature vector; and generating the first self-correlation feature by applying the self-attention mechanism to the fused feature vector.

The generating of the first cross-correlation feature of the query image and the second cross-correlation features of the respective reference images by inputting the first self-correlation feature and the second self-correlation features into the first cross-attention unit may include: generating a third feature vector by stitching feature vectors respectively corresponding to pixel blocks of the first self-correlation feature; generating a fourth feature vector by stitching feature vectors respectively corresponding to pixel blocks of the second self-correlation feature; generating a third semantic slot sequence corresponding to the third feature vector and a fourth semantic slot sequence corresponding to the fourth feature vector, respectively; generating a fifth semantic slot sequence corresponding to the third semantic slot sequence and a sixth semantic slot sequence corresponding to the fourth semantic slot sequence by applying a cross-attention mechanism to the third semantic slot sequence and the fourth semantic slot sequence, respectively; and generating the first cross-correlation feature and the second cross-correlation feature based on the fifth semantic slot sequence, the sixth semantic slot sequence, the third feature vector, and the fourth feature vector.

The determining of the pose of the target object may include: selecting a target reference image from among the reference images based on a semantic feature corresponding to the query image, semantic features corresponding to each of the respective reference images, and similarity information associated with positional information between the query image and each of the reference images; and determining the pose of the target object based on the query image and the target reference image.

The determining of the target reference image from among the reference images may include: for a first reference image of the reference images, determining a second pixel of the first reference image that is most similar to a first pixel of the query image from among pixels of the first reference image corresponding to a first position range with respect to the first pixel of the query image, based on the semantic feature of the query image and a semantic feature of the first reference image; for the first reference image, determining a third pixel of the first reference image that is most similar to the second pixel of the first reference image from among pixels of the query image corresponding to a second position range with respect to the second pixel of the first reference image, based on the semantic feature of the query image and the semantic feature of the first reference image; and determining the target reference image from among the reference images based on the first pixel, the second pixel, and the third pixel.

The determining of the target reference image from among the reference images based on the first pixel, the second pixel, and the third pixel may include: for each reference image, determining a preset number of second pixel pairs from among first pixel pairs for a corresponding reference image, in order of similarity, wherein each of the first pixel pairs includes the first pixel and the third pixel corresponding to the first pixel, and each of the second pixel pairs includes the first pixel and the second pixel corresponding to the first pixel; fusing similarities of the second pixel pairs; and determining the target reference image from among the reference images, based on the fused similarity of the second pixel pairs for each reference image.

The determining of the pose of the target object based on the query image and the target reference image may include: generating a similarity matrix based on the first semantic feature of the query image and a second target semantic feature of the target reference image; optimizing the similarity matrix based on first saliency information of the query image, second target saliency information of the target reference image, first geometric consistency information of the query image, or second target geometric consistency information of the target reference image; and determining the pose of the target object based on the optimized similarity matrix, a depth image corresponding to the query image, and a target depth image corresponding to the target reference image.

A non-transitory computer-readable storage medium may store instructions that, when executed by a processor, cause the processor to perform any of the methods.

In another general aspect, an electronic device includes: one or more processors; and a memory storing instructions configured to cause the one or more processors to: obtain a query image; obtain reference images corresponding to the query image, wherein the reference images are obtained based on having respective reference objects therein that have a same object type as an object type in the query image; determine a first semantic feature and first information corresponding to the query image, wherein the first information includes first geometric information of the query image or first positional information of the query image; determine second semantic features and second pieces of information of the respectively corresponding reference images, wherein the second pieces of information each include second geometric information or second positional information of their respectively corresponding reference images, each reference image having a corresponding second semantic feature and second piece of information; and determine a pose of the target object based on (i) the first semantic feature and the first information and (ii) the second semantic features and the second pieces of information.

The instructions may be further configured to cause the one or more processors to: generate a first association feature of the query image based on the first semantic feature and the first geometric information of the query image; generate a second association feature of the query image based on the second semantic feature and the second pieces of geometric information of the reference images; and determine the pose of the target object based on the first association feature and the second association feature.

The instructions may be further configured to cause the one or more processors to: based on determining that the target object in the query image is not registered in a database, obtain, as the reference images, images of the target object having respective poses thr

The instructions may be further configured to cause the one or more processors to: generate correlation matrixes of correlation between the query image and each of the respectively corresponding reference images based on the first association feature and the second association feature, wherein each correlation matrix represents a relative position of a first pixel block of the query image with respect to a positionally-corresponding second pixel block its corresponding reference image; and determine the pose of the target object based on the correlation matrixes.

The instructions may be further configured to cause the one or more processors to: select a target reference image from among the reference images based on a semantic feature corresponding to the query image, a semantic feature corresponding to each of the reference images, and similarity information associated with positional information between the query image and each of the reference images; and determine the pose of the target object based on the query image and the target reference image.

Other features and aspects will be apparent from the following detailed description, the drawings, and the claims.

### BRIEF DESCRIPTION OF THE DRAWINGS

FIG. 1 illustrates an example method of determining a pose of an object in a query image according to one or more example embodiments.

FIG. 2 illustrates an example method of determining a reference image corresponding to a query image to estimate a pose according to one or more example embodiments.

FIG. 3 illustrates an example of performing a pose estimation method using a smartphone according to one or more example embodiments.

FIG. 4 illustrates an example method of registering a type of a new object according to one or more example embodiments.

FIG. 5 illustrates an example architecture of a neural network model for pose estimation according to one or more example embodiments.

FIG. 6 illustrates an example architecture of an attention mechanism module according to one or more example embodiments.

FIG. 7A illustrates an example processing flow of a first self-attention unit according to one or more example embodiments.

FIG. 7B illustrates another example processing flow of a first self-attention unit according to one or more example embodiments.

FIG. 8A illustrates an example processing flow of a cross-attention unit according to one or more example embodiments.

FIG. 8B illustrates another example processing flow of a cross-attention unit according to one or more example embodiments.

FIG. 9 illustrates an example processing flow of a pose post-processing module according to one or more example embodiments.

FIG. 10 illustrates an example loss function acquisition process during a training process of a neural network model for pose estimation according to one or more example embodiments.

FIG. 11 illustrates an example configuration of an electronic device according to one or more example embodiments.

FIG. 12 illustrates an example method of determining a target reference image according to one or more example embodiments.

FIG. 13 illustrates an example method of determining a pose of a target object according to one or more example embodiments.

Throughout the drawings and the detailed description, unless otherwise described or provided, the same or like drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

At least some functions or features of an electronic device for implementing examples and embodiments disclosed herein may be implemented by an artificial intelligence (AI) model. For example, at least one of multiple modules of the electronic device may be implemented by an AI model. In this case, AI-related functions may be performed by a non-volatile or volatile memory (not a signal per se) and a processor.

The processor may include one or more processors. The one or more processors may be, as non-limiting examples, a general-purpose processor (e.g., a central processing unit (CPU), an application processors (AP), etc.), a pure graphics processing unit (GPU) (e.g., a GPU, a visual processing unit (VPU), etc.), and/or an AI-specific processor (e.g., a neural processing unit (NPU)).

The one or more processors may control the processing of input data according to predefined operational rules or AI models stored in the non-volatile memory and the volatile memory. The predefined operational rules or the AI models may be provided through learning or training.

In this case, “provided by learning or training” may indicate obtaining an AI model with the predefined operational rules or desired characteristics by applying a learning algorithm to sets of training data, possibly through multiple epochs. Such learning or training may be performed by the electronic device itself on which AI is performed according to example embodiments, and/or may be implemented by a separate server/device/system. That is to say, training may be performed on one device and inference using a trained model(s) may be performed on another device.

An AI model may be a neural network that includes layers of nodes. Each of the layers may perform a neural network computation (operation) between data input to a layer (e.g., a computation result of a previous layer and/or input data of the AI model) and weight values of the layer. In this case, a neural network may be/include, as non-limiting examples, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), or a deep Q network. The techniques described herein may be applicable to any type of neural network architecture. Generally, each layer may have connections to a preceding layer (and/or other layers), except an input layer. The connections may have weights, and the weights of connections to a given node, as applied to inputs on those connections, may control an output or activation of the given node. Training or learning may update the weights.

The learning algorithm may train a predetermined target device (e.g., a robot) using sets of training data to guide, allow, or control the target device to make decisions or predictions. The learning algorithm may include, as non-limiting examples, supervised learning, unsupervised learning, semi-supervised learning, reinforcement learning, or continual learning.

The technologies, techniques, methods, or operations described herein may relate to one or more technical fields, such as, for example, speech, language, image, video, or data intelligence.

Optionally, in the field of speech or language, a method performed by an electronic device according to one or more example embodiments of the present disclosure may be used to perform user speech recognition and user intent interpretation. The method may receive a speech signal as an analog signal via a speech signal acquisition device (e.g., a microphone) and convert a speech portion into a computer-readable text using an automatic speech recognition (ASR) model. The method may also interpret the text using a natural language understanding (NLU) model to obtain the intent of utterance of the user. The ASR model or the NLU model may be an AI model. The AI model may be processed by a dedicated AI processor designed with a hardware architecture specified for processing AI models. The AI model may be obtained through training. The expression “obtained by training” may indicate obtaining the predefined operating rules or AI models of a desired feature (or objective) by training a basic AI model with various training data using a learning or training algorithm. Here, language understanding refers to a technology used to recognize, apply, and process human languages/texts, including natural language processing, machine translation, dialog systems, question and answer, or speech recognition/synthesis.

Optionally, in the field of images or videos, the method performed by the electronic device according to one or more example embodiments of the present disclosure may be used to perform object identification. The method may use image data as input data for an AI model to obtain output data identifying an image or features of the image. The AI model may be obtained through training. The method may relate to the field of visual understanding of AI technology, which is a technology for recognizing and processing objects, as in human vision. The field of visual understanding of AI technology may include, for example, object recognition, object tracking, image retrieval, person recognition, scene recognition, three-dimensional (3D) reconstruction/positioning, or image enhancement.

Optionally, in the field of data intelligence processing, the method performed by the electronic device according to one or more example embodiments of the present disclosure may be used to perform object category inference or prediction. The method may infer or predict a category of an object based on feature data, using an AI model. A processor of the electronic device may perform preprocessing on the data to convert the data into a form suitable to be used as an input to the AI model. The AI model may be obtained through training. In this case, the inference and prediction may refer to a technique for making logical inferences and predictions by determining information, including knowledge-based inference, optimization prediction, preference-based planning, or recommendations.

Throughout the present disclosure, elements or components included in an example embodiment, and other elements or components having the same features or functions, are described using the same names in other example embodiments. Unless otherwise stated, the description of one example embodiment is applicable to the other example embodiments, and its detailed and repeated description is omitted when it is considered redundant.

Examples and embodiments described herein may address a need for reinforced pose estimation models to estimate poses of new/untrained objects, i.e., objects that were not included in training samples used to train the models.

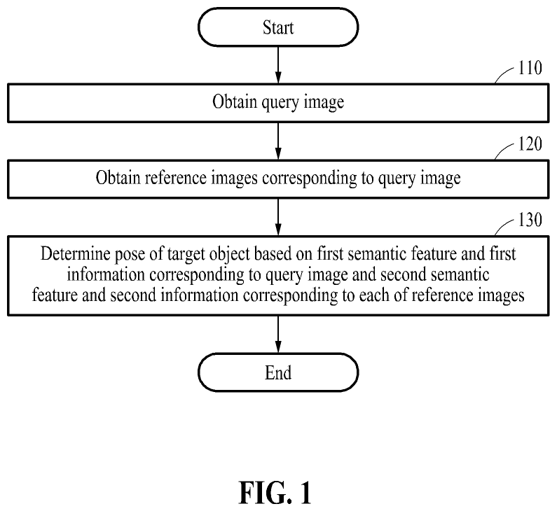

FIG. 1 illustrates an example method of determining a pose of an object in a query image according to one or more example embodiments.

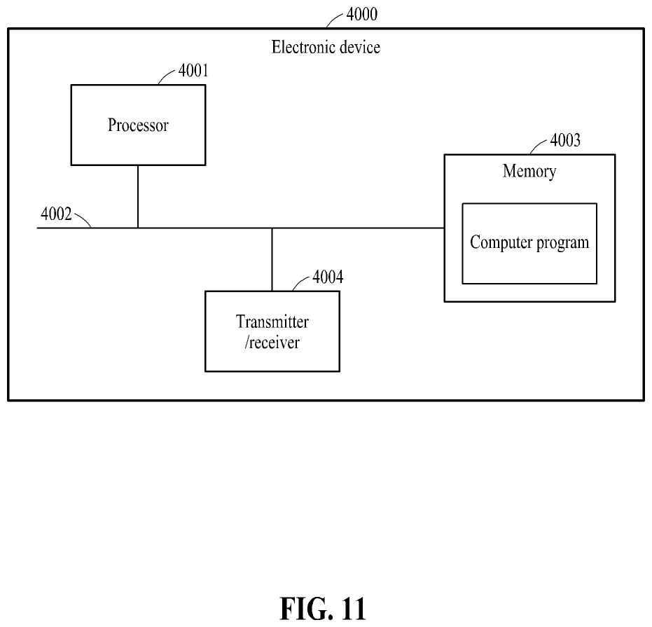

According to an example embodiment, a method of determining a pose of an object in a query image may include operations 110 to 130. For example, operations 110 to 130 may be performed by an electronic device. The electronic device may be, for example, a handheld device or a server. The structure or configuration of the electronic device is described with reference to FIG. 11.

In operation 110, the electronic device may obtain a query image. In the query image, there may be an object image of a physical object. The term “object” may be used interchangeably with the “object image” when it is described below in connection with the term “image.” An object in the query image that requires pose determination (or estimation), possibly among one or more objects included in the query image, may be referred to herein as a “target object.”

For example, the electronic device may receive the query image from an external electronic device connected to the electronic device. The external electronic device may be, for example, a mobile communication terminal such as a smartphone. The external electronic device may generate the query image using a camera of the external electronic device and transmit the generated query image to the electronic device.

In operation 120, the electronic device may obtain reference images corresponding to the query image. For example, each of the reference images may include a reference object of the same object type/class as the target object included in the query image.

Poses of the reference objects may be known, and the poses may differ from each other.

According to an example embodiment, the target object in the query image and the reference objects in the reference images may be the same object (or instance), or they may be different objects. For example, the type of the target object in the query image and the type of the reference object in a reference image may be a “bicycle.” However, when the target object in the query image is a “sports bicycle” and the reference object in the reference image is a “recreational bicycle,” the target object and the reference object may be different objects. An object type and kinds of objects belonging to the object type may be set according to actual needs and are not limited to the example embodiments described herein.

According to an example embodiment, the query image and the reference images may each include a red, green, and blue (RGB) image data and a depth image. For example, the query image may include an RGB image (or a query RGB image) and a depth image (i.e., a query depth image), and the reference images may each include an RGB image (i.e., a reference RGB image) and a depth image (i.e., a reference depth image). The query image including the RGB image and the depth image may be referred to as an RGBD image (or a query RGBD image). The reference images each including an RGB image and a depth image may be referred to as RGBD images (or reference RGBD images).

After obtaining the query image, the electronic device may obtain the reference images corresponding to the query image, and determine whether the type of the reference object in each of the reference images is the same as the type of the target object in the query image.

In operation 130, the electronic device may determine a pose of the target object based on (i) a first semantic feature and first information corresponding to the query image and (ii) for each of the reference images, a respectively corresponding second semantic feature and second information. The first information corresponding to the query image may include a first geometric information feature of the query image and/or first positional information of the query image. Each second information may include a second geometric information feature and/or second positional information of the corresponding reference image.

According to an example embodiment, the first information corresponding to the query image may include geometric information features, and operation 130 may include operations SA1 and SA2 described below. Operation SA1 may include operation SA1a and operation SA1b.

In operation SA1a, the electronic device may generate a first association feature corresponding to the query image based on the first semantic feature and the first geometric information feature of the query image. For each of the reference images, the electronic device may generate a corresponding second association feature, and may do so based on the second semantic feature and the second geometric information feature of the corresponding reference image. A geometric information feature of an image (e.g., the query image or the reference images) may represent a shape feature of an object (e.g., the target object or the reference object) in the image. The shape feature may be, for example, a feature of a visual shape of the object, such as, for example, a circle, a square, or the like.

The electronic device may obtain the first semantic feature and the first geometric information feature of the query image, and generate the first association feature corresponding to the query image by combining the first semantic feature and the first geometric information feature.

In operation SA1b, the electronic device may obtain the second semantic feature and the second geometric information feature of each of the reference images, and generate the second association feature corresponding to each reference image by combining the second semantic feature and the second geometric information feature of each reference image.

In operation SA2, the electronic device may determine the pose of the target object based on the first association feature of the query image and based the second association features of the respective reference images. The electronic device may estimate the pose of the target object based on the first association feature and the second association features, and may finally obtain a pose estimation result of estimating the pose of the target object.

According to an example embodiment, the pose of the target object may be determined as a six degrees of freedom (6DoF) pose that includes three position dimensions (e.g., down, front-back, and left-right) in addition to three rotation angles. Methods of determining the pose of a target object described herein may be used in augmented reality (AR) systems, virtual reality (VR) systems, robotic systems, or the like.

The methods of determining the pose of a target object described herein may be used to estimate a pose of a new/untrained object. The estimating of the pose of the new object (also simply referred to herein as “pose estimation”) may significantly improve the generalization ability of a model and thus improve the sensation of immersion in AR and VR, the accuracy in real-time rendering, and the accuracy in robotic grasping. The methods of determining the pose of a target object described herein may determine the pose of a target object using only one query image, and the methods may thus process an RGBD video sequence frame by frame.

The methods of determining the pose of the target object described herein may determine the pose of the target object in the query image using the first association feature (which is for the first semantic feature and the first geometric information feature of the query image) and using the second association features, which are for the second semantic feature and the second geometric information feature of the respective reference images. The methods of determining the pose of the target object described herein may determine a pose of a new/untrained target object (in the query image) having the same object type/class as reference objects included in the respective reference images (that is, the reference objects may also be of the new/untrained object type/class).

According to an example embodiment, methods of determining the pose of the target object described herein may further include determining (or identifying) the target object in the query image, and obtaining the reference images based on the reference images corresponding to the query image based on the target object (i.e., the reference images may be obtained/selected based on having objects therein that correspond to the target object). Specifically, after obtaining the query image, the electronic device may determine the target object based on the query image and may obtain at least one reference image based on the reference image including a reference object that corresponds to the target object. The type of the object included in the obtained reference image may be the same as the type of the target object, which may also serve as a basis for selecting the reference image. For example, the same object type may indicate that different objects belong to the same category. For example, an object representing a red bicycle, an object representing a blue bicycle, and an object representing a mountain bicycle all have the same object type (e.g., bicycle).

According to an example embodiment, the operation of obtaining the reference images may include: in a case where the target object is an object registered in a database directly or indirectly connected to the electronic device, the reference images that each include the reference object corresponding to the target object may be obtained from the database.

According to an example embodiment, the obtaining the reference images may include: in a case where the target object is not registered in the database, obtaining, as the reference images, images of the target object having respective different poses collected via an image acquisition device directly or indirectly connected to the electronic device (the image acquisition device having sensors to sense the camera's pose when an image is captured).

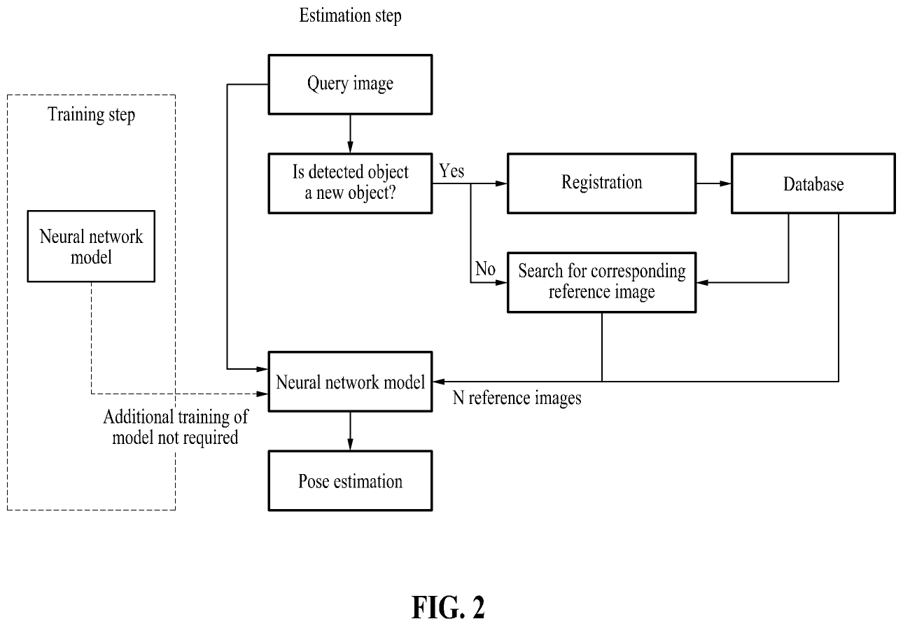

As shown in FIG. 2, after the target object in the query image is determined (e.g., by an object recognition algorithm or model), the reference images corresponding to the query image may be obtained using one of two methods.

In a first method, an image including a reference object having the same object type/class as the target object in the query image in a preset database that is directly or indirectly connected to the electronic device may be obtained as a reference image. In a case where the object type corresponding to the target object is already registered in the database, the target object may be a registered object.

In a second method, in a case where there is no image in the preset database that includes an object having the same object type as the target object, the electronic device may obtain the reference images in a preset manner through an external device (e.g., an image acquisition device or a video acquisition device). In a case where the object type corresponding to the target object is not registered in the database, the electronic device may store, in the database, the reference images that are obtained through the external device. By storing the new reference images in the database, the electronic device may register the new object type of the target object.

According to an example embodiment, the electronic device may determine the pose of the target object in the query image by inputting the query image and the reference images, however acquired, into a neural network model for object pose estimation. For example, the neural network model may be a model trained in advance to determine the poses of target objects in query images.

According to an example embodiment, the operation of obtaining the reference images may include: an operation of obtaining one or more captured images including the reference object corresponding to the target object and obtaining, as a reference image, a captured image that satisfies a preset condition among the one or more captured images. For example, the preset condition may be that respective reference objects included in the captured images have different poses. For example, the preset condition may include that a pixel size corresponding to the reference object in each of the captured images falls within a specified size range.

According to an example embodiment, the operation of obtaining the reference images may include: an operation of obtaining an image including the reference object corresponding to the target object and obtaining, as reference images, one or more frames in the image that satisfy a preset condition. For example, the preset condition may be that respective reference objects included in the frames take different poses. For example, the preset condition may be that a pixel size of the reference object included in each of the frames fall within a specified size range.

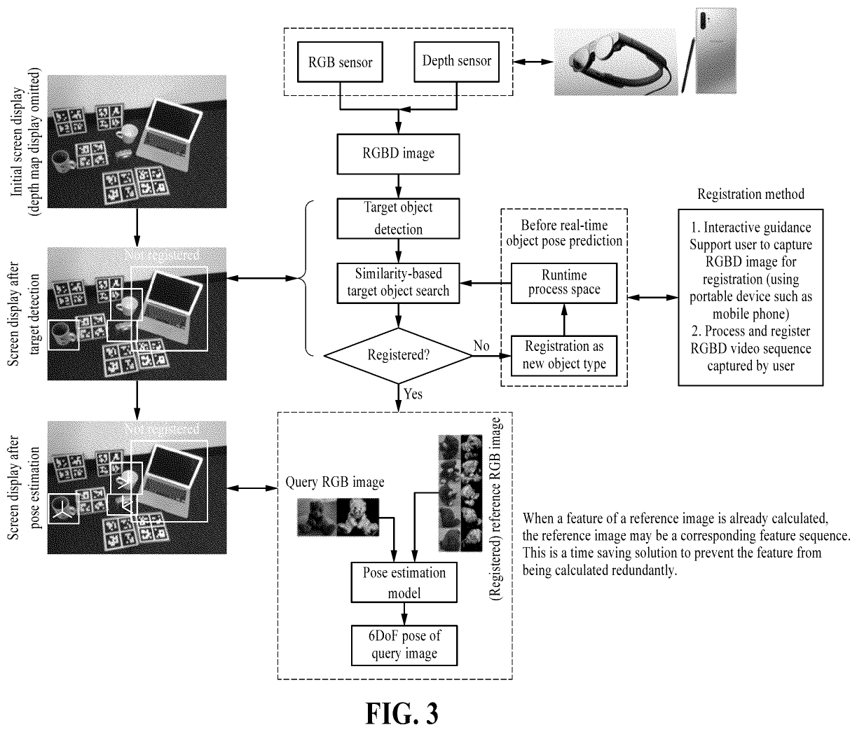

As shown in FIG. 3, in a case where the electronic device is a smartphone, the electronic device may obtain, as a query image, RGBD information of a target object through an RGB sensor and a depth sensor provided in the electronic device. The electronic device may detect the target object present in the query image by executing an object detection module, and may crop an area corresponding to the detection of the target object. The electronic device may execute a similarity search module based on the cropped RGBD image to determine whether the target object is an object registered in the database.

In a case where the target object is an unregistered object, the electronic device may register the type of the target object as a new object type. To register the type of the target object as a new object type, the electronic device may calculate features of the target object. In a case where the object type of the target object is not registered in the database, the electronic device may display an “unregistered” box (e.g., a phrase “not registered!” as shown in the drawing) on a screen (or display) of the electronic device. In a case where the object type of the target object is registered in the database, the electronic device may display a “registered” box (e.g., the phrase “not registered!” not shown) on the screen (or display) of the electronic device.

The electronic device may execute a pose estimation module, and the pose estimation module may then call an existing reference image (or features of the reference image) from the database, match it to the query image in the “registered” box to determine a pose of the target object, and then display the determined pose of the target object in the form of a coordinate system within the “registered box.” For example, in the query image, the “registered” box and the “unregistered” box may be displayed in different colors to be differentiated from each other.

According to an example embodiment, the new object type may be registered using the following two methods.

First method: in a case where the electronic device is a handheld device (e.g., a smartphone), the electronic device may interactively guide a user to register one or more RGBD images in the database using the electronic device. For example, the electronic device may guide the user through voice guidance, haptic feedback, text or pop-up window guidance, or the like.

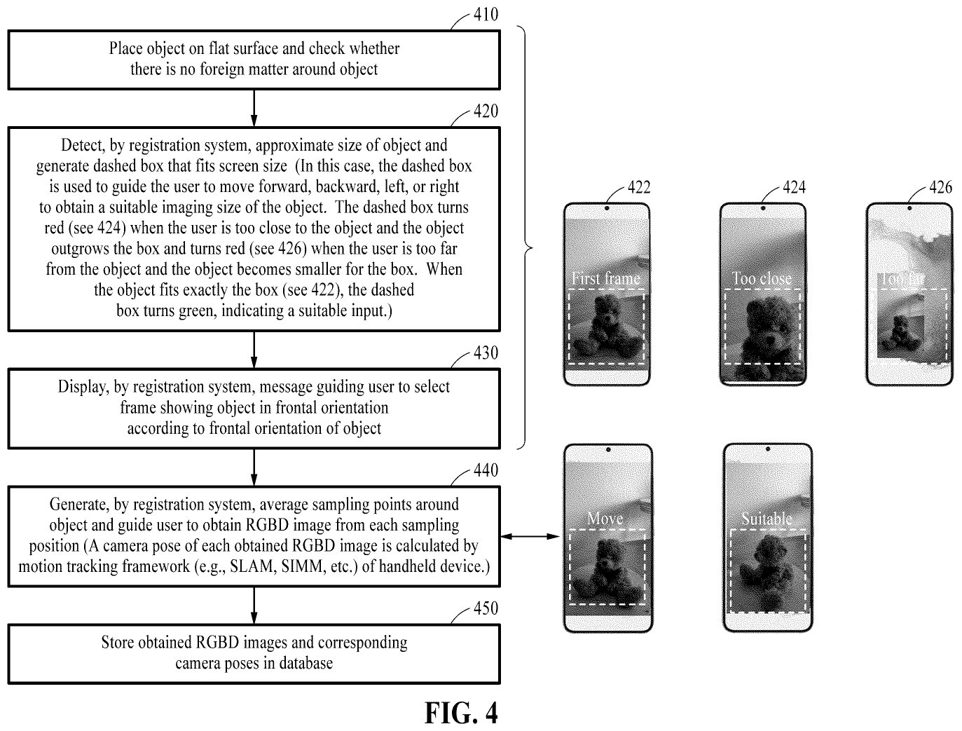

The user may be guided through registration as shown in FIG. 4.

In operation 410, a registration system of the electronic device may guide the user to place an object (e.g., a target object) on a flat surface and check to be sure there is no foreign object around the object (i.e., a plain scene). The user may capture an image or video of the object using a camera (e.g., an RGB sensor and a depth sensor) of the electronic device.

In operation 420, the registration system of the electronic device may repeatedly detect a rough size of the target object in the generated image or video and generate a dashed box that fits the size of a screen to include the target object. The dashed box may be used to guide the user to move a point of view (also referred to herein as a viewing point) at the time of capturing the image forward, backward, leftward, or rightward to obtain a suitable imaging size of the object.

For example, referring to screen 424, the dashed box may turn red when the target object on the screen increases in size because the viewing point is too close to the object. No box color is shown on screen 424.

For example, referring to screen 426, the dashed box may turn red when the target object on the screen decreases in size because the viewing point is too far from the object. No box color is shown on screen 426.

For example, referring to screen 422, the dashed box may turn green when the target object on the screen is appropriate in size because the viewing point is appropriate. No box color is shown on screen 422. The green box may indicate that the viewing point satisfies a requirement.

In operation 430, the registration system of the electronic device may guide the user to select a frame showing the object facing a frontal orientation. For example, in a case where a plurality of images of a plurality of objects is generated, or a video including a plurality of frames is generated, the electronic device may guide the user to select an image or frame indicating a frontal orientation of an object.

In operation 440, the registration system of the electronic device may generate average sampling points around the object and guide the user to capture an RGBD image at each sampling position. A camera pose corresponding to each obtained RGBD image may be calculated by a motion tracking framework (e.g., simultaneous localization and mapping (SLAM) or single in-line memory module (SIMM)) of the handheld device.

In operation 450, the registration system of the electronic device may complete registration of a new object type by storing the obtained RGBD image and the corresponding camera pose in the database.

Second method: in a case where the electronic device is a handheld device (e.g., a smartphone), the electronic device may guide the user to register a new object type in the database using an RGBD video captured through the electronic device.
(i) The registration system of the electronic device may guide the user to upload an RGBD video of an object (e.g., a target object) onto the electronic device.
(ii) The registration system of the electronic device may execute a motion restoration algorithm (e.g., SLAM or structure from motion (SfM)) to obtain a camera pose for a frame of the video. The electronic device may execute a longest distance sampling algorithm to select positions of a series of reference images. Finally, a reference image sequence (which may also be a reference image feature sequence) including a pose may be returned.

To obtain a high-quality video, the user may need to ensure the adequacy of the imaging size of an object by placing the object on a solid and flat surface free of foreign matters and maintaining a suitable distance between the camera and the object while generating the video, and may need to capture the video of the object horizontally.

The electronic device may determine a pose of the target object in the query image by obtaining the reference images corresponding to the query image and then inputting the query image and the reference images into a neural network model for pose estimation.

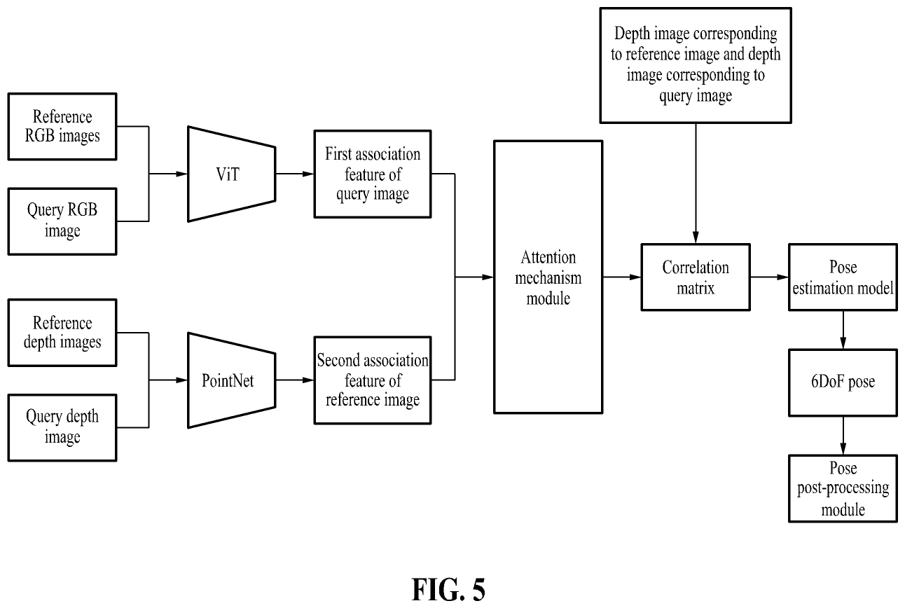

As shown in FIG. 5, a neural network model for pose estimation may include a semantic feature extraction module, a geometric information extraction module, an attention network for obtaining correlation features, and a pose estimation module for determining a pose. The functions and processing flows of the modules of the neural network model for pose estimation will be described in detail below.

According to an example embodiment, an operation (e.g., operation SA1a) of obtaining a corresponding first association feature based on a first semantic feature and a first geometric information feature of a query image may include an operation of generating the first association feature by aligning and stitching the first semantic feature and the first geometric information feature for each pixel block.

According to an example embodiment, the operation (e.g., operation SA1a) of obtaining the first association feature corresponding to the query image based on the first semantic feature and the first geometric information feature of the query image may include an operation of generating the first association feature by inputting the first semantic feature and the first geometric information feature into the neural network model.

According to an example embodiment, an operation (e.g., operation SA1b) of generating a second association feature corresponding to a reference image based on a second semantic feature and a second geometric information feature of the reference image may include an operation of generating the second association feature by aligning and stitching the second semantic feature and the second geometric information feature for each pixel block.

According to an example embodiment, the operation (e.g., operation SA1b) of generating the second association feature corresponding to the reference image based on the second semantic feature and the second geometric information feature of the reference image may include an operation of generating the second association feature by inputting the second semantic feature and the second geometric information feature into the neural network model.

The first semantic feature of the query image may be obtained based on an RGB image of the query image. The first geometric information feature of the query image may be obtained based on a depth image of the query image. The second semantic feature of the reference image may be obtained based on an RGB image of the reference image. The second geometric information feature of the reference image may be obtained based on a depth image of the reference image.

The semantic feature extraction module may be configured using a vision transformer (e.g., ViT) which is a neural network-based feature extractor. ViT may be a self-supervised vision transformer and may be trained in advance using ImageNet-1K (a known dataset). An output size of a semantic feature output through ViT may be M×N×D, where M×N denotes the size of a pixel block of an input image and D denotes a feature dimension.

There may be two methods used to extract (or generate) semantic features. A first method of extracting semantic features may extract, as a semantic feature, a feature output from a feature layer (e.g., a last/output layer of the layers of the transformer) of the transformer. A second method of extracting semantic features may generate a semantic feature by stitching values obtained after a principal component analysis (PCA) (which may have three dimensions) of all feature layers of the transformer.

The geometric information feature extraction module may be configured using PointNet (e.g., a point cloud network) which is a neural network for processing depth information and point clouds. PointNet may perform a task of segmenting components of ShapeNet (a known dataset) to obtain pre-training weights. An output size of a geometric information feature to be output may be M×N×H, where M×N denotes the size of a pixel block of an input image and H denotes a feature dimension.

By inputting an RGB query image and RGB reference images into the ViT, the electronic device may output the first semantic feature of the query image and the second semantic feature of each reference image. By inputting a depth image corresponding to the query image and depth images respectively corresponding to the reference images into PointNet, the electronic device may output the first geometric information feature of the query image and the second geometric information feature of each reference image.

The electronic device may generate the first association feature corresponding to the query image by combining the first semantic feature and the first geometric information feature of the query image. The electronic device may generate the second association feature corresponding to each reference image by combining the second semantic feature and the second geometric information feature of each reference image. An association feature described herein may be generated by merging the semantic feature and the geometric information feature. For example, the association feature may be generated by aligning a semantic feature and a geometric information feature for each pixel block and stitching the semantic feature and the geometric information feature.

According to an example embodiment, the operation of determining the pose of the target object based on the first association feature and the second association feature may include: an operation of generating a correlation matrix of correlation between the query image and each of the reference images based on the first association feature and the second association feature, where the correlation matrix may indicate a relative position of a first pixel block of the query image with respect to a second pixel block of each of the reference images corresponding to the first pixel block of the query image; and an operation of determining the pose of the target object based on the correlation matrix.

According to an example embodiment, the operation of generating the correlation matrix between the query image and each of the reference images based on the first association feature and the second association feature may include: an operation of generating the correlation matrix of correlation between the query image and each of the reference images by inputting the first association feature and the second association feature into the attention network (“attention mechanism module”).

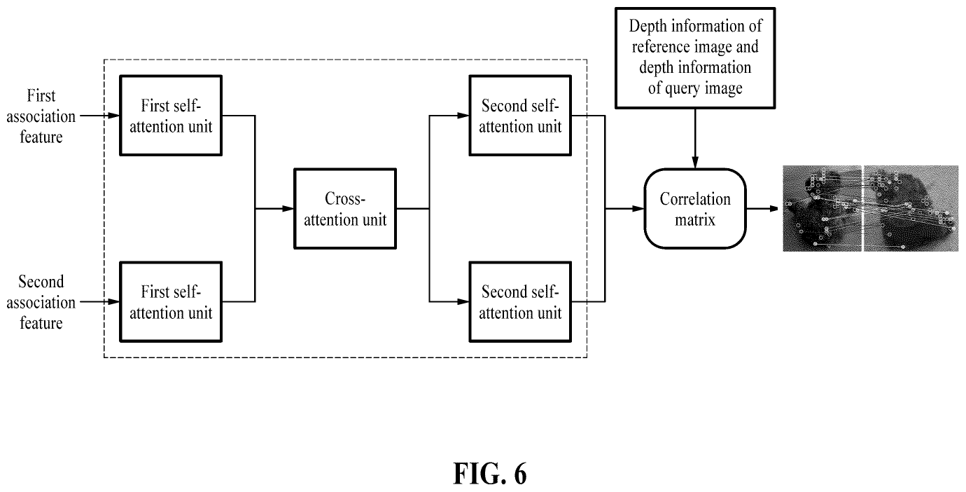

According to an example embodiment, the attention network may include a first attention module (see FIG. 6). The first attention module may include two first self-attention units connected in parallel, a first cross-attention unit, and two second self-attention units connected in parallel.

According to an example embodiment, the operation of generating the correlation matrix correlating the query image and each of the reference images by inputting the first association feature and the second association feature into the attention network may include: an operation of generating a first self-correlation feature of the query image and a second self-correlation feature of each of the reference images by inputting the first association feature and the second association feature into the first self-attention units; an operation of generating a first cross-correlation feature of the query image and a second cross-correlation feature of each of the plurality of reference images by inputting the first self-correlation feature and the second self-correlation feature into the first cross-attention unit; an operation of generating a third self-correlation feature of the query image and a fourth self-correlation feature of each of the plurality of reference images by inputting the first cross-correlation feature and the second cross-correlation feature into the second self-attention units; and an operation of generating the correlation matrix between the query image and each of the reference images based on the third self-correlation feature and the fourth self-correlation feature.

According to an example embodiment, the attention network may further include one or more second attention modules. Each of the second attention modules may include a second cross-attention unit and two third self-attention units connected in parallel. An input to each second attention module may be a self-correlation feature generated by a previous second attention module. A self-correlation feature generated by a corresponding second attention module may be used as an input to a next second attention module.

According to an example embodiment, the operation of generating the correlation matrix between the query image and each of the reference images may include: an operation of generating the correlation matrix correlating the query image and each of the reference images based on a self-correlation feature generated by a last second attention module of the second attention modules.

According to an example embodiment, the attention network may include a normalized exponential function layer. Through the normalized exponential function layer, the electronic device may generate the correlation matrix based on the self-correlation features output by the first attention module or the self-correlation feature output by the last second attention module.

The attention network may include a sequentially cascaded first attention module and a normalized indicator function layer. The attention network may include a sequentially cascaded first attention module, one or more second attention modules, and a normalized indicator function layer.

For example, the attention units in the attention network may each operate based on a bi-slot mechanism. The first attention module may include a bi-slot self-attention module (e.g., the first self-attention units and the second self-attention units) and a bi-slot cross-attention module (e.g., the first cross-attention unit). A second attention module may include a bi-slot cross-attention module (e.g., the second cross-attention unit) and a bi-slot self-attention module (e.g., the third self-attention units). A combination of a self-attention mechanism and a cross-attention mechanism of the second attention module may be performed multiple times to obtain a specific feature correlation.

The electronic device may input the first association feature of the query image and the second association feature of the reference image to the bi-slot self-attention module (e.g., the first self-attention units), respectively, to obtain an intrinsic feature correlation. Outputs of the bi-slot self-attention module may then be input into the bi-slot cross-attention module to obtain a feature cross-correlation between the query image and each reference image. Subsequently, an output of the bi-slot cross-attention module may be input to the bi-slot self-attention module (e.g., the second self-attention units) to generate the correlation matrix. The electronic device may determine a relative pose (e.g., a pose delta) of a target object in the query image with respect to a reference object in the reference image, based on the correlation matrix, depth information of the reference image, and depth information of the query image. For example, the relative pose of the target object in the query image with respect to the reference object in the reference image may be determined based on a YUSHE algorithm (e.g., an Umeyama algorithm).

As shown in FIG. 6, the attention network may include only the first attention module and no second attention module. Respective inputs to the two parallel first self-attention units may be the first association feature and the second association feature.

The first self-attention unit to which the first association feature is input may generate an intrinsic correlation of the query image. The first self-attention unit to which the first association feature is input may output a first self-correlation feature corresponding to the query image. The first self-attention unit to which the second association feature is input may generate an intrinsic correlation of a reference image. The first self-attention unit to which the second association feature is input may output a second self-correlation feature corresponding to the reference image.

An input to the cross-attention unit (e.g., the first cross-attention unit) may be the first self-correlation feature and the second self-correlation feature. The cross-attention unit may generate a correlation between the query image and the reference image. The cross-attention unit may output a first cross-correlation feature corresponding to the query image and a second cross-correlation feature of the reference image, respectively.

The first cross-correlation feature and the second cross-correlation feature may be input to the second self-attention units, respectively. The second self-attention unit to which the first cross-correlation feature is input may regenerate an intrinsic correlation of the query image. The second self-attention unit to which the first cross-correlation feature is input may output a third self-correlation feature of the query image. The second self-attention unit to which the second cross-correlation feature is input may regenerate an intrinsic correlation of the reference image. The second self-attention unit to which the second cross-correlation feature is input may output a fourth self-attention feature of the reference image.

The third self-correlation feature and the fourth self-correlation feature may be input to a softmax layer (e.g., the normalized indicator function layer). The softmax layer may finally output the correlation matrix correlating the query image and the reference image.

According to an example embodiment, the operation of generating the first self-correlation feature of the query image by inputting the first association feature into the first self-attention unit may include: an operation of generating a first feature vector by stitching feature vectors corresponding to respective pixel blocks of the first association feature; an operation of generating a first semantic slot sequence corresponding to the first feature vector; an operation of generating a second semantic slot sequence by applying the self-attention mechanism to the first semantic slot sequence; and an operation of generating the first self-correlation feature based on the second semantic slot sequence and the first feature vector. A pixel block described herein may include one or more corresponding pixel points (positionally correlated pixel positions) between the reference image and the query image.

According to an example embodiment, the operation of generating the first self-correlation feature based on the second semantic slot sequence and the first feature vector may include: an operation of generating the first self-correlation feature by stitching the first feature vector and a feature vector generated by upsampling the second semantic slot sequence.

As an association feature of the query image or the reference image in the bi-slot self-attention module (e.g., the first self-attention units, the second self-attention units, or the third self-attention units) are flattened pixel by pixel, a vector corresponding to the association features may be generated. The bi-slot self-attention module may generate the first semantic slot sequence (or a first semantic block sequence) corresponding to the vector by applying a slot attention mechanism to the vector. Each slot may respectively correspond to a specific semantic feature or a specific geometric feature of a feature image. By applying the self-attention module to slot features, a correlation between slots, for example, the second semantic slot sequence, may be generated. Subsequently, as the slots are upsampled through a multilayer perceptron (MLP) module, a feature vector with the same dimension as a flattened vector may be obtained. The flattened vector and the feature vector may be stitched through a 1*1 convolutional layer, and a final vector may thereby be generated.

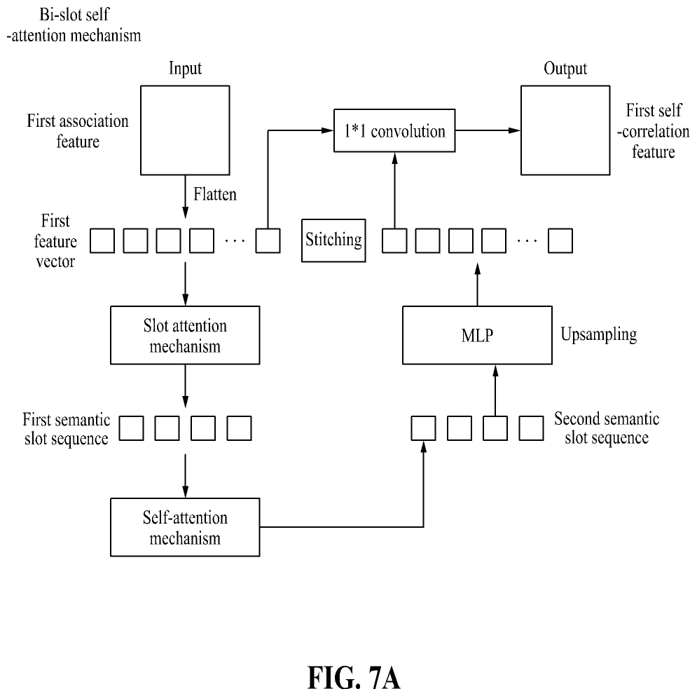

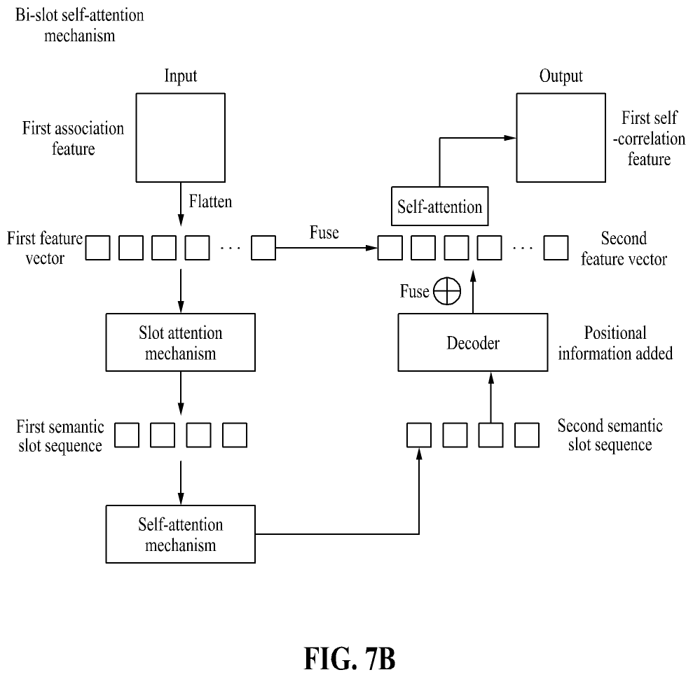

Next, to describe an example processing process of each self-attention unit, a method of generating a first self-correlation feature is described with reference to FIG. 7A.

The electronic device may flatten a first association feature, pixel by pixel, to generate a first feature vector corresponding to the first association feature. A dimension of the first feature vector may be equal to the number of pixels of the first association feature. The electronic device may process the first feature vector using the slot attention mechanism to generate a first semantic slot sequence corresponding to the first feature vector. The electronic device may apply the self-attention mechanism to the first semantic slot sequence to generate a second semantic slot sequence corresponding to the first semantic slot sequence. The electronic device may upsample the second semantic slot sequence using an MLP to generate a feature vector having the same dimension as the dimension of the first feature vector. The electronic device may stitch the first feature vector and the upsampled feature vector through a 1*1 convolution to generate a first self-correlation feature corresponding to a query image.

According to an example embodiment, the operation of generating the first self-correlation feature based on the second semantic slot sequence and the first feature vector may include: an operation of, for each semantic slot of the second semantic slot sequence, generating a processed semantic slot by expanding a semantic slot into the same number of pixel blocks as the first association feature; an operation of generating a semantic slot feature vector having the same feature dimension as the first feature vector by decoding the processed semantic slot according to positional information; an operation of generating a second feature vector by fusing feature vectors of pixel blocks at the same position among semantic slot feature vectors; an operation of generating a fused feature vector by fusing the first feature vector and a feature vector of a pixel block at the same position in the second feature vector; and an operation of generating the first self-correlation feature by applying the self-attention mechanism to the fused feature vector.

A process of generating a second semantic slot sequence shown in FIG. 7B may be the same as the process described above with reference to FIG. 7A. However, a process of generating a first self-correlation feature based on a second semantic slot sequence and a first feature vector, shown in FIG. 7B, may be different from the process described above with reference to FIG. 7A.

According to an example embodiment, for each slot in a second semantic slot sequence, the electronic device may generate the same number of pixel blocks as a first association feature and may add (or display), to each pixel block, positional information corresponding to each pixel block. The positional information of each pixel block may include row information and column information of a position of each pixel block in an expanded matrix. The electronic device may input each semantic slot (e.g., a processed semantic block) having the expanded and added positional information to a decoder (e.g., the decoder may include three CNNs). The decoder may output a semantic slot feature vector having the same feature dimension as a first feature vector to generate a semantic slot feature vectors. For each of the semantic slot feature vectors, the electronic device may fuse feature vectors of pixel blocks at the same position to generate a second feature vector. For example, the electronic device may generate the second feature vector by summing and averaging the feature vectors of the pixel blocks at the same position for each of the semantic slot feature vectors. For example, the electronic device may generate the second feature vector by first assigning a weight to each of the feature vectors of the pixel blocks at the same position for each of the semantic slot feature vectors, and summing and averaging the feature vectors based on the weight (i.e., may find a weighted average). The electronic device may then fuse the first feature vector and a feature vector of a pixel block at the same position in the second feature vector and apply the self-attention mechanism to the fused feature vector to generate the first self-correlation feature. For example, a feature dimension of the first feature vector and a feature dimension of the second feature vector may be the same (same feature dimension size), and thus the first feature vector and the second feature vector may be directly added.

A processing process of another first self-attention unit and another second self-attention unit of the first attention module is similar to the process described above and will thus not be repeated here.

According to an example embodiment, the attention network may include one sequentially cascaded first attention module and one or more second attention modules. A processing process of each attention unit of each attention module of the attention network is similar to the process described above and will not be repeated here. For example, in a case where the attention network includes a second attention modules, the second attention modules may be cascaded sequentially.

According to an example embodiment, the operation of generating the first cross-correlation feature of the query image and the second cross-correlation feature of each of the reference images by inputting the first self-correlation feature and the second self-correlation feature into the first cross-attention unit may include: an operation of generating a third feature vector by stitching feature vectors corresponding to respective pixel blocks of the first self-correlation feature; an operation of generating a fourth feature vector by stitching feature vectors corresponding to respective pixel blocks of the second self-correlation feature; an operation of generating a third semantic slot sequence corresponding to the third feature vector and a fourth semantic slot sequence corresponding to the fourth feature vector, respectively; an operation of generating a fifth semantic slot sequence corresponding to the third semantic slot sequence and a sixth semantic slot sequence corresponding to the fourth semantic slot sequence by applying the cross-attention mechanism to the third semantic slot sequence and the fourth semantic slot sequence, respectively; and an operation of generating the first cross-correlation feature and the second cross-correlation feature based on the fifth semantic slot sequence, the sixth semantic slot sequence, the third feature vector, and the fourth feature vector.

According to an example embodiment, the operation of generating the first cross-correlation feature and the second cross-correlation feature based on the fifth semantic slot sequence, the sixth semantic slot sequence, the third feature vector, and the fourth feature vector may include: an operation of generating the first cross-correlation feature by stitching a feature vector generated by upsampling the fifth semantic slot sequence with the third feature vector; and an operation of generating the second cross-correlation feature by stitching a feature vector generated by upsampling the sixth semantic slot sequence with the fourth feature vector.

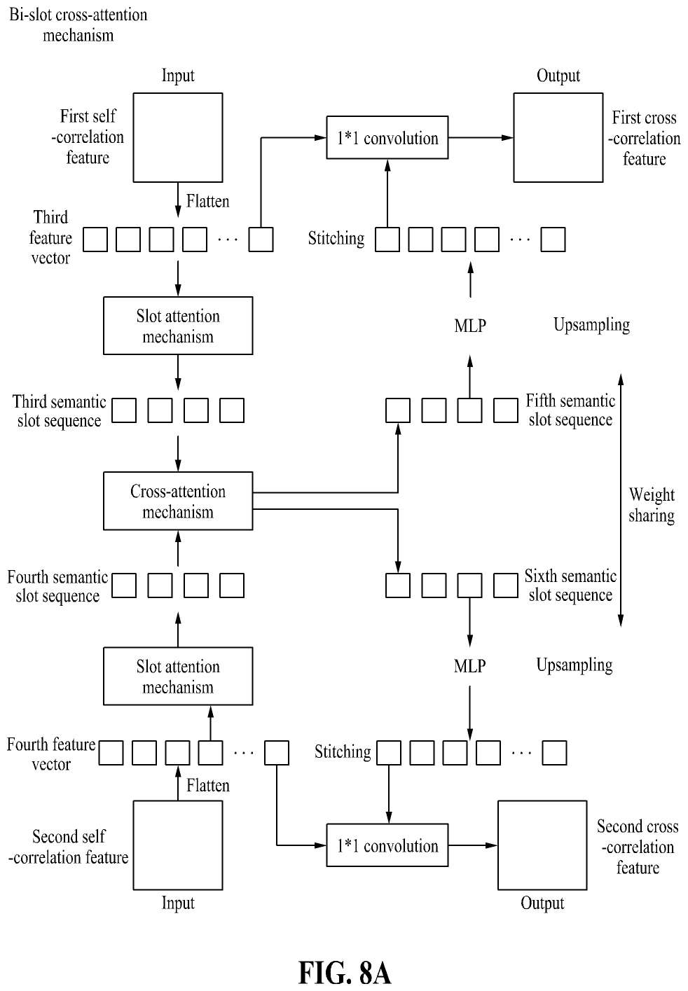

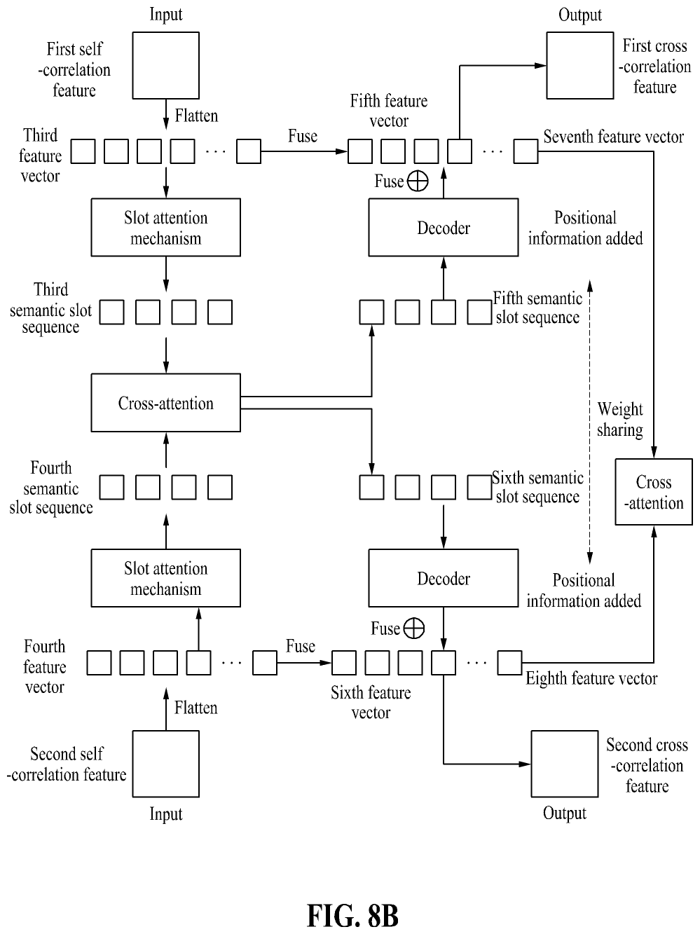

According to an example embodiment, a processing process of the bi-slot cross-attention module is described below. The electronic device may: generate feature vectors by flattening, pixel by pixel, a first self-correlation feature of a query image and a second self-correlation feature of a reference image; generate semantic slot sequences by applying the slot attention mechanism to the generated feature vectors; and generate information cross-correlation between slots by applying the cross-attention mechanism to the generated semantic slot sequences. The electronic device may generate feature vectors by upsampling each of the semantic slot sequences generated by the cross-attention mechanism through an MLP sharing weights, and may generate final output vectors by stitching each of the generated feature vectors with its original feature vector. The final output vectors may be generated by a 1*1 convolutional module. A method of generating the final output vectors is described in detail below with reference to FIG. 8A.

The electronic device may generate the third feature vector corresponding to the first self-correlation feature by flattening the first self-correlation feature pixel by pixel, and may generate the fourth feature vector corresponding to the second self-correlation feature by flattening the second self-correlation feature pixel by pixel. Here, flattening the first self-correlation feature may refer to converting the first self-correlation feature with 2D or 3D information into 1D information.

The electronic device may generate the third semantic slot sequence corresponding to the third feature vector by applying the slot attention mechanism to the third feature vector, and may generate the fourth semantic slot sequence corresponding to the fourth feature vector by applying the slot attention mechanism to the fourth feature vector.

The electronic device may generate the fifth semantic slot sequence corresponding to the third semantic slot sequence by applying the cross-attention mechanism to the third semantic slot sequence, and may generate the sixth semantic slot sequence corresponding to the fourth semantic slot sequence by applying the cross-attention mechanism to the fourth semantic slot sequence.

The electronic device may generate a feature vector corresponding to the fifth semantic slot sequence by upsampling the fifth semantic slot sequence through the MLP, and may generate a feature vector corresponding to the sixth semantic slot sequence by upsampling the sixth semantic slot sequence through the MLP. The MLP may share weights for the fifth semantic slot sequence and the sixth semantic slot sequence.

The electronic device may generate the first cross-correlation feature for the feature vector corresponding to the fifth semantic slot sequence and the third feature vector through the 1*1 convolutional module, and may generate the second cross-correlation feature for the feature vector corresponding to the sixth semantic slot sequence and the fourth feature vector through the 1*1 convolutional module.

According to an example embodiment, the operation of generating the first cross-correlation feature and the second cross-correlation feature based on the fifth semantic slot sequence, the sixth semantic slot sequence, the third feature vector, and the fourth feature vector may include: for each semantic slot of the fifth semantic slot sequence and the sixth semantic slot sequence, an operation of generating a processed semantic slot by expanding a semantic slot into the same number of pixel blocks as the first self-correlation feature or the second self-correlation feature, and generating a semantic slot feature vector having the same feature dimension as the third feature vector or the fourth feature vector by decoding the processed semantic slot according to positional information; an operation of generating a fifth feature vector by fusing feature vectors of pixel blocks at the same position in each semantic slot feature vector corresponding to the first self-correlation feature; an operation of generating a sixth feature vector by fusing feature vectors of pixel blocks at the same position in each semantic slot feature vector corresponding to the second self-correlation feature; an operation of generating a seventh feature vector by fusing feature vectors of pixel blocks at the same position in the third feature vector and the fifth feature vector; an operation of generating an eighth feature vector by fusing feature vectors of pixel blocks at the same position in the fourth feature vector and the sixth feature vector; an operation of generating the first cross-correlation feature by applying the cross-attention mechanism to the seventh feature vector; and an operation of generating the second cross-correlation feature by applying the cross-attention mechanism to the eighth feature vector.

A process of generating the fifth semantic slot sequence and the sixth semantic slot sequence, shown in FIG. 8B, may be the same as the process described above with reference to FIG. 8A. However, a process of generating the first cross-correlation feature and the second cross-correlation feature based on the fifth semantic slot sequence, the sixth semantic slot sequence, the third feature vector, and the fourth feature vector, shown in FIG. 8B, may be different from the process described above with reference to FIG. 8A.

After generating the fifth semantic block sequence, the electronic device may generate the seventh feature vector by expanding each semantic block, decoding each expanded semantic block based on positional information, and fusing the expanded semantic blocks. After generating the sixth semantic block sequence, the electronic device may generate the eighth feature vector by expanding each semantic block, decoding each expanded semantic block based on positional information, and fusing the expanded semantic blocks.

The electronic device may generate the first cross-correlation feature and the second cross-correlation feature by applying the cross-attention mechanism to the seventh feature vector and the eighth feature vector, respectively. In this case, expanding each semantic block, positional information-based decoding, and fusing may be the same as a principle of the process of generating the first self-correlation feature described above, and will thus not be repeated here.

In the processing process of the attention network described above, the bi-slot self-attention mechanism for generating a semantic feature and a geometric information feature, and the bi-slot cross-attention mechanism for generating an association between the semantic feature and the geometric information feature may improve the accuracy of a generated correlation matrix, and the improved accuracy of the correlation matrix may improve the accuracy of a determined pose of a target object.

For example, fₛ may be defined as a semantic feature portion of the first self-correlation feature and expressed by Equation 1 below. f_{g} may be defined as a geometric information feature portion of the first self-correlation feature and may be expressed by Equation 2 below.

$${f}_{s} ∈ {ℝ}^{L \times {D}_{1}} \qquad Equation 1$$

$${f}_{g} ∈ {ℝ}^{L \times {D}_{2}} \qquad Equation 2$$

In Equation 1 and Equation 2, L denotes a feature dimension of the first self-correlation feature. D₁ denotes a feature dimension of a semantic feature, and D₂ denotes a feature dimension of a collective feature.

For example, fᵢₙ may be defined as the first self-correlation feature and may be expressed by Equation 3 below.

$${f}_{in} = \{ {f}_{s} , {f}_{g} \} ∈ {ℝ}^{L \times ( {D}_{1} + {D}_{2} )} \qquad Equation 3$$

The slot self-attention mechanism used by the first cross-attention unit to process the third feature vector corresponding to the first self-correlation feature may use Equation 4 below.

$${f}_{sslot} = {slot}_{s} ( {f}_{s} ) ∈ {ℝ}^{{M}_{1} \times D} \qquad Equation 4$$

$${f}_{gslot} = {slot}_{g} ( {f}_{g} ) ∈ {ℝ}^{{M}_{2} \times D}$$

In Equation 4, fₛₛₗₒₜ and f_{gslot} denote semantic slots corresponding to fₛ and f_{g}, respectively, M₁ and M₂ denote the numbers of slots corresponding to fₛ and f_{g}, respectively, D denotes a dimension of a corresponding slot, and fₛₛₗₒₜ and f_{gslot} may constitute the third semantic slot sequence.

A method of generating the fifth semantic slot sequence based on the third semantic slot sequence and a method of generating the sixth semantic slot sequence based on the fourth semantic slot sequence will be described below.

$${f}_{sout} = Decoder ( cross ( {f}_{sslot} ) + position ) ∈ {ℝ}^{L \times D} \qquad Equation 5$$

$${f}_{gout} = Decoder ( cross ( {f}_{gslot} ) + position ) ∈ {ℝ}^{L \times D}$$

In Equation 5, fₛₒᵤₜ denotes a feature vector corresponding to fₛₛₗₒₜ, f_{gout} denotes a feature vector corresponding to f_{gslot}, Decoder denotes a decoder, and cross denotes the cross-attention mechanism. fₛₒᵤₜ and f_{gout} may constitute a fifth feature vector fₒᵤₜ that constitutes the third semantic slot sequence. The fifth feature vector fₒᵤₜ may be expressed using Equation 6.

$${f}_{out} = concate ( {f}_{sout} , {f}_{gout} ) \qquad Equation 6$$

In Equation 6, concate denotes stitching.

As the fifth feature vector and the third feature vector are summed, the seventh feature vector may be generated. As the sixth feature vector and the fourth feature vector are summed, the eighth feature vector may be generated. As the seventh feature vector and the eighth feature vector are processed using the cross-attention mechanism, the first cross-correlation feature for seventh feature information and the second cross-correlation feature for eighth feature information may be generated. The first cross-correlation feature and the second cross-correlation feature may be expressed using Equation 7.

$${f}_{cross\_out}^{1} , {f}_{cross\_out}^{2} = cross ( {f}_{out}^{1} + {f}_{in}^{1} , {f}_{out}^{2} + {f}_{in}^{2} ) \qquad Equation 7$$

In Equation 7, fᵢₙ¹ denotes the third feature vector, fₒᵤₜ¹ out denotes the fifth feature vector, fᵢₙ² denotes the fourth feature vector, fₒᵤₜ² denotes the sixth feature vector, f_{corss_out}¹ denotes the first cross-correlation feature, and f_{corss_out}² denotes the second cross-correlation feature.

A process of generating the second feature vector based on the first semantic slot sequence, which is performed by the first self-attention units, will be described below.

$${f}_{out} = Decoder ( self ( {slot}_{in} ( {f}_{in} ) ) + position ) \qquad Equation 8$$

$$or$$

$${f}_{sout / gout} = concate ( Decoder ( self ( {slot}_{s / g} ( {f}_{s / g} ) ) + position ) )$$

In Equation 8, f_{sout/gout} denotes the second feature vector, self denotes the self-attention mechanism, slot_{s/g} (f_{s/g}) denotes the first semantic slot sequence, concate denotes stitching, Decoder denotes decoding, position denotes positional information, and slotᵢₙ (fᵢₙ) denotes the first semantic slot sequence.

A method of generating the first self-correlation feature and the second self-correlation feature, which is performed by the first self-attention units and the second self-attention units, will be described below.

$${f}_{self\_out}^{1} , {f}_{self\_out}^{2} = self ( {f}_{out}^{1} + {f}_{in}^{1} , {f}_{out}^{2} + {f}_{in}^{2} ) \qquad Equation 9$$

In Equation 9, fᵢₙ¹ denotes the first feature vector corresponding to the query image, fₒᵤₜ¹ denotes the second feature vector corresponding to the query image, fᵢₙ² in denotes the first feature vector corresponding to a reference image, fₒᵤₜ² denotes the second feature vector corresponding to the reference image, f_{self_out}¹ denotes the first self-correlation feature corresponding to the query image, and f_{self_out}² denotes the second self-correlation feature corresponding to the reference image.

According to an example embodiment, the operation of determining the pose of the target object in the query image based on the correlation matrix correlating the query image with each of the reference images generated based on the first association feature and the second association feature may include: an operation of determining candidate reference images based on a correlation value of a position set for each correlation matrix, wherein each of the candidate reference images may be a reference image whose viewing angle difference from the query image is not greater than a first predetermined threshold value; an operation of determining a target reference image from among the candidate reference images, wherein the target reference image may be a candidate reference image having the largest number of correlation values greater than or equal to a second predetermined threshold value included in a correlation matrix corresponding to each of the candidate reference images, among the candidate reference images; an operation of determining a first preset number of target pixel pairs having the largest correlation value between different image blocks of the target reference image and different image blocks of the query image, based on a correlation matrix corresponding to the target reference image; and an operation of determining the pose of the target object based on a first target pixel pair corresponding to each image block of the target reference image.

According to an example embodiment, the operation of determining the pose of the target object based on the first target pixel pair corresponding to each image block of the target reference image may include: an operation of determining a second preset number of target pixel pairs having the largest correlation value among the first target pixel pairs corresponding to respective image blocks of the target reference image, based on the correlation matrix corresponding to the target reference image, wherein the second preset number may not be greater than the first preset number; and an operation of determining the pose of the target object based on the second preset number of target pixel pairs.

Each reference image and the query image may have a corresponding correlation matrix (that is, the reference images may have respective correlation matrices), and each value (a correlation value) in a correlation matrix may represent a correlation between a pixel in the corresponding reference image and a corresponding pixel in the query. That is, a correlation between pixel points in the query image and pixel points in the reference image may be represented as a correlation value corresponding to the pixel points in the correlation matrix.

For example, among the reference images, reference images having a large viewing angle difference from the query image may be first filtered out. To elaborate, based on a correlation value in the upper left corner of the correlation matrix corresponding to each reference image, a parallax difference between a corresponding reference image and the query image may be determined. Subsequently, after at least one reference image having the large viewing angle difference is filtered out, unfiltered reference images may become candidate reference images. Subsequently, an optimal reference image, i.e., the target reference image, may be determined from among the candidate reference images. In this case, in a candidate reference image, a pixel point having a correlation value greater than a predetermined threshold value may be determined as a highly correlated pixel point, and a candidate reference image having the largest number of such highly correlated pixel points may be determined as the target reference image.

After the target reference image is determined, reference-query pixel pairs with a high correlation may be determined to determine the pose of the target object; the high correlations may be determined based on the correlation matrix between the target reference image and the query image. The target reference image and the query image may each be divided into an equal number of image blocks. Based on the correlation matrix corresponding to the target reference image, a first preset-number of pixel pairs having the highest correlation among image blocks of the target reference image and corresponding image blocks of the query image may be determined, and a second preset-number of pixel pairs may then be determined from among the first preset-number of pixel pairs corresponding to each image block of the target reference image. Based on the second preset-number of pixel pairs, the pose of the target object in the query image may be determined.

According to an example embodiment, the operation of determining the pose of the target object in the query image based on each correlation matrix may include: an operation of determining the pose of the target object in the query image based on each correlation matrix, a depth image of the query image, and a depth image of each reference image.

After the correlation matrix between the query image and each reference image is determined, a relatively optimal correlation matrix may be determined based on the correlation matrices for the reference images, and a reference image corresponding to the optimal correlation matrix may be determined as an optimal reference image. As the optimal correlation matrix, the depth image of the query image, and a depth image of the optimal reference image are input to the pose estimation module, the pose of the target object in the query image may be determined.

According to an example embodiment, the pose estimation neural network may further include a pose post-processing module. The pose post-processing module may optimize a result output from the pose estimation module and may thereby determine a more accurate pose of the target object. A processing process of the pose post-processing module will be described in more detail below.

According to an example embodiment, the operation of determining the pose of the target object in the query image based on each correlation matrix, the depth image of the query image, and the depth image of each reference image may include: an operation of determining a first pose of the target object based on each correlation matrix, the depth image of the query image, and the depth image of each reference image; an operation of generating a template model for an object in each reference image based on semantic features and depth images of the reference images (the template model may be a 3D point cloud representation of the object having semantic features); an operation of generating a semantic feature of an image corresponding to the object in the first pose, based on the template model; and an operation of determining the pose based on the semantic feature of the image corresponding to the object in the first pose and a semantic feature of the query image.

For example, the operation of generating the template model for the object in each reference image based on the semantic features and the depth images of the reference images may include: for each reference image, an operation of obtaining point cloud data corresponding to the object in a reference image based on a depth image of the reference image; and an operation of generating the template model based on the point cloud data corresponding to the object in the reference images and the semantic features of the reference images.

For example, the operation of generating the semantic feature of the image corresponding to the object in the first pose based on the template model may include: an operation of generating the semantic feature of the image corresponding to the object in the first pose through depth texture rendering of the template model.

For example, the operation of determining the pose based on the semantic feature of the image corresponding to the object in the first pose and the semantic feature of the query image may include: an operation of generating, based on a difference between the semantic feature of the image corresponding to the object in the first pose and the semantic feature of the query image, a semantic feature of an image corresponding to an object in a second pose until the difference between the semantic feature of the image corresponding to the object in the second pose and the semantic feature of the query image is not greater than a predetermined threshold value, using the template model; and an operation of determining the second pose as the pose of the target object.

The pose post-processing module may be used to generate a single template model based on the semantic features and the depth images of the reference images. The target object to be recognized may be construed as corresponding to the template model. The template model may be used to generate a semantic feature under a specific angle based on the depth texture rendering. The ViT model may be used to generate the semantic feature of the query image, using a query RGB image. An initial pose may be a 6DoF pose determined through a correlation matrix calculation. This may gradually reduce a difference between the semantic feature of the query image and a semantic feature generated by the template model for a different pose (e.g., different angle) through a Levenberg-Marquardt method to ultimately generate a pose result optimized for the initial pose.

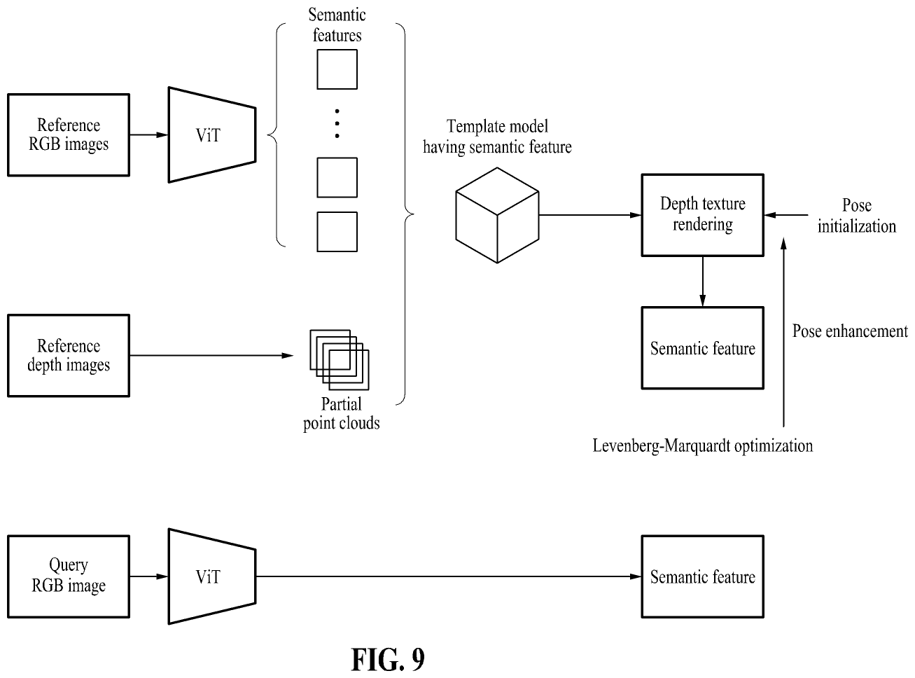

As shown in FIG. 9, a pose determined through the pose estimation module based on a correlation matrix may be determined as an initial pose, and the initial pose may be optimized through the pose post-processing module to be determined as an optimized pose. First, a corresponding template model may be generated based on semantic features and depth images of one or more reference images. For example, point clouds respectively corresponding to the objects may be generated based on corresponding depth images of the reference images, and a template model may be generated based on the point cloud corresponding to each object and a semantic feature of each reference image. The template model may be rotated by a specified angle according to a requirement, and a semantic feature with the specified angle may be generated based on the template model.

Subsequently, a semantic feature corresponding to an initial pose may be generated based on the template model. Specifically, an angle corresponding to the initial pose may be determined, and a semantic feature of the template model with the angle obtained by depth texture rendering may be determined as the semantic feature corresponding to the initial pose.

The semantic feature corresponding to the initial pose determined by the template model may be compared to a semantic feature corresponding to a query image, and in this case, the Levenberg-Marquardt optimization may be used to reduce a difference between the two semantic features. For example, when the difference between the two semantic features is greater than a preset threshold value, a semantic feature for the template model may be generated by fine-tuning the angle of the template model and then performing the depth texture rendering, and the generated semantic feature corresponding to the template model may be continuously compared to the semantic feature of the query image. When the difference between the two semantic features is still greater than the preset threshold value, a semantic feature corresponding to the template model may be obtained by continuing to fine-tune the template model, and may then be continuously compared to the semantic feature corresponding to the query image until the difference between the two semantic features is not greater than the preset threshold value. When the difference between the two semantic features is not greater than the threshold value, a current pose corresponding to the template model may be determined as an optimized pose of a target object.

Next, a training process for the pose estimation neural network is described according to an example embodiment. In a training step, a query RGBD image and each reference RGBD image may be input to the pose estimation neural network, and the pose estimation neural network may then generate a pixel-level correlation matrix between the two images. The correlation matrix may be annotated by projecting point clouds of two instances. In an initial annotation operation, the two instances may be matched and aligned through manual key point matching, and a relative pose between the two point clouds may be determined through the matching and aligning. In addition, a relative pose between each reference image and the query image may be determined based on an initial annotation of CO3D (a known dataset). Based on the relative pose, the point clouds may be projected onto the corresponding images, and the pixel-level correlation matrix between the two images may thereby be determined.

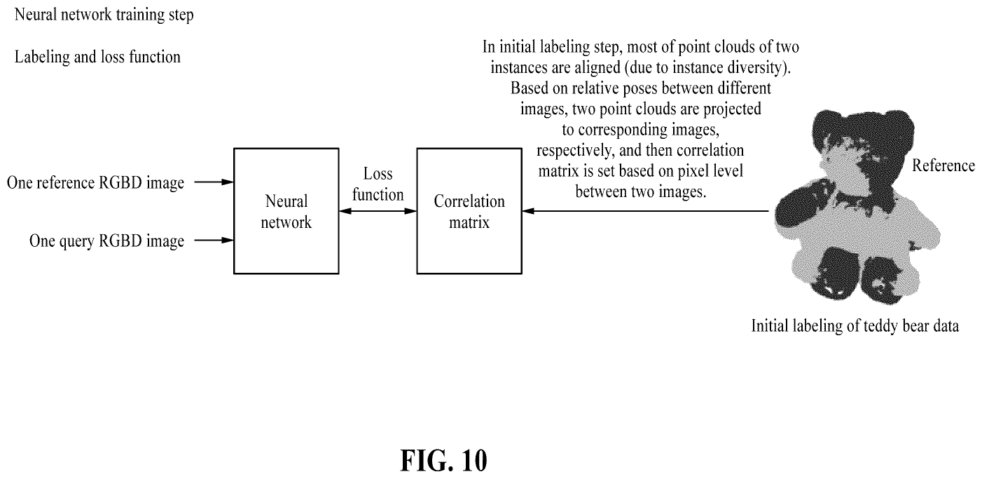

As shown in FIG. 10, a loss function for determining the correlation matrix may be expressed by Equation 10 below.

$${L}_{c} = \frac{1}{\vert {M}_{c}^{gt} \vert} {\sum }_{( \tilde{i} , \tilde{j} ) ∈ {M}_{c}^{gt}} log {P}_{c} ( \tilde{i} , \tilde{j} ) . \qquad Equation 10$$

In Equation 10, M_{c}^{gt} denotes a mask of an actual value of the correlation matrix, P_{c} denotes a predicted correlation matrix, and (i, j) denotes row and column indices of the matrix, respectively. For example, each mask value in M_{c}^{gt} may be 1, and each mask value may correspond to a position in the correlation matrix that needs to be reset. For example, M_{c}^{gt} may cover a position of an upper left corner of the correlation matrix, that is, reset an actual value at the upper left corner in the correlation matrix to 1.

During the training process of the pose estimation neural network, in a case where a viewing angle difference between two images is too large and there are too few pixel points corresponding to each other, the following two solutions may be proposed.

(1) A specific method of sampling and interpolating corresponding pixel points (e.g., a pixel pair) of two images (e.g., image 1 and image 2) is as follows. For the two images, two pairs of pixel points (also simply referred to herein as two pixel point pairs) may be selected respectively, and interpolation sampling may be performed on an area between two pixel points in each image. For example, in a case where (x1, x2) and (y1, y2) are two randomly sampled pixel points of image 1, and (a1, a2) and (b1, b2) in image 2 are two pixel points positionally corresponding to (x1, x2) and (y1, y2) of image 1, the interpolation sampling may be performed according to Equation 11 below:

$$( {z}_{1} , {z}_{2} ) = ( {x}_{1} + ∝ ( {y}_{1} - {x}_{1} ) , {x}_{2} + β ( {y}_{2} - {x}_{2} ) ) \qquad Equation 11$$

$$( {c}_{1} , {c}_{2} ) = ( {a}_{1} + ∝ ( {b}_{1} - {a}_{1} ) , {a}_{2} + β ( {b}_{2} - {a}_{2} ) )$$

$$∝ , β ∈ ( 0 , 1 )$$

In Equation 11, a and B denote ratio parameters in x and y directions, respectively, and (z1, z2) and (c1, c2) represent pixel points obtained after the interpolation sampling is performed on image 1 and image 2, respectively.

(2) When the number of actual corresponding pixel pairs in sampled images is still smaller than a threshold value (e.g., it may be 5), a value of a first pixel in an upper left corner of a final correlation matrix may be set to 1. In a pose determination operation, it may be assumed that the larger the value in the upper left corner of the matrix, the greater the difference in viewing angle between the images.

According to an example embodiment, first information corresponding to a query image may include positional information, and operation 130 described above may include the following operations.

In operation SB1, the electronic device may determine a target reference image from among obtained reference images based on a first semantic feature corresponding to the query image, a second semantic feature corresponding to each of the reference images, and similarity information associated with first positional information of the query image and second positional information of each of the reference images.

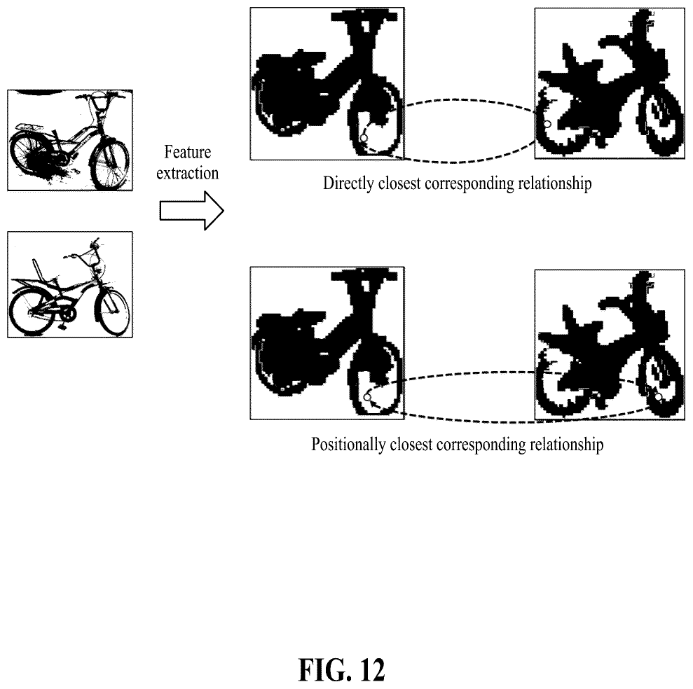

The target reference image for the query image may be a “positionally closest neighboring image” with respect to the query image among the reference images that is limited by positional information. As shown in FIG. 12, the “positionally closest neighboring image” may be more accurate in terms of feature matching than a “directly closest image,” as shown by the feature mismatch in the top half of FIG. 12.

In operation SB2, the electronic device may determine a pose of a target object based on the query image and the target reference image. The electronic device may finally determine the pose of the target object by estimating and/or optimizing the pose of the target object based on the query image and the target reference image. The pose of the target object to be determined may be, for example, a 6DoF pose of the target object.

According to an example embodiment, the electronic device may determine the pose of the target object by first determining the target reference image for the query image from among the reference images, restoring the pose based on the query image and the target reference image, and comparing a pose of an object included in the target reference image to the pose of the target object in the query image.

According to an example embodiment, the operation of determining the target reference image from among the reference images based on the first semantic feature corresponding to the query image, the second semantic feature corresponding to each of the reference images, and the similarity information associated with the positional information of the query image and the positional information of each of the reference images may include: for a first reference image among the reference images, an operation of determining a second pixel that is most similar to a first pixel among pixels of the first reference image corresponding to a first position range with respect to the first pixel of the query image, based on the first semantic feature of the query image and a semantic feature of the first reference image; for the first reference image, an operation of determining a third pixel that is most similar to the second pixel among pixels of the query image corresponding to a second position range with respect to the second pixel of the first reference image, based on the first semantic feature of the query image and the semantic feature of the first reference image; and an operation of determining the target reference image from among the reference images, based on the first pixel, the second pixel, and the third pixel.

For example, the first position range for the first pixel may be determined in advance or may be determined by real-time computation (e.g., computation using a predetermined algorithm or neural network), but is not limited thereto.

The electronic device may generate the first semantic feature corresponding to the query image and the second semantic features respectively corresponding the reference images, using the semantic feature extraction module. For example, the semantic feature extraction module may adopt a self-distillation with no labels (DINO) network model or other neural network models. The electronic device may generate the first semantic feature of the query image and the second semantic feature of each reference image by inputting an RGB image corresponding to the query image and an RGB image corresponding to each reference image into the DINO network.

For example, the query image and one of the reference images may be I₁ and I₂, respectively, and f(I₁), f(I₂)∈R^{H′×W′×D} may be the first semantic feature (of the query image I₁) and the second semantic feature (of the reference image I₂) generated by the semantic feature extraction module, respectively. The first semantic feature and the second semantic feature may be of the same size. In this case, when it is assumed that (a, b) is an index of one first pixel of the query image, i.e., a∈{1, . . . , H′}, b∈{1, . . . , W′}, an index (c, d) of a second pixel of the reference image that is most similar to the first pixel (a, b) may be calculated as expressed by Equation 12 below.

$$( c , d ) = arg {min}_{( i , j )} d ( {f ( {I}_{1} )}_{( a , b )} , {f ( {I}_{2} )}_{( i , j )} ) \qquad Equation 12$$

In Equation 12, d( ) denotes a similarity, and d( ) may optionally use a L2 distance but is not limited thereto. argmin denotes a variable (i, j) calculated such that the function d( ) has a minimum value.

In the process of calculating the second pixel (c, d), a condition on a position range may be added as expressed by Equation 13 below.

$$distance ( ( a , b ) , ( c , d ) ) < k \qquad Equation 13$$

In Equation 13, distance( ) denotes a distance between (a, b) and (c, d), and a method of calculating the distance may optionally be, but is not limited to, a method of calculating a Manhattan distance. A value of k may be preset or may vary depending on an actual situation.

An index (a′, b′) of a third pixel of the query image I₁ that is most similar to the second pixel (c, d) may be calculated as expressed by Equation 14 below.

$$( {a}^{′} , {b}^{′} ) = arg {min}_{( i , j )} d ( {f ( {I}_{1} )}_{( i , j )} , {f ( {I}_{2} )}_{( c , d )} ) \qquad Equation 14$$

Based on (a, b) and (a′, b′) corresponding thereto, a mapping relationship map C∈R^{H′×W′} may be generated as expressed by Equation 15 below.

$${C}_{( a , b )} = d ( ( a , b ) , ( {a}^{′} , {b}^{′} ) ) \qquad Equation 15$$

In the process of calculating the third pixel (a′, b′), a condition on a position range may be added as expressed by Equation 16 below.

$$distance ( ( a , b ) , ( {a}^{′} , {b}^{′} ) ) < k \qquad Equation 16$$

The target reference image may be determined from among the reference images based on the first pixel, the second pixel, and the third pixel corresponding to each of the reference images.

According to an example embodiment, the operation of determining the target reference image from among the reference images based on the first pixel, the second pixel, and the third pixel corresponding to each reference image may include: an operation of determining a preset number of second pixel pairs in a preset order starting from one with the highest similarity from among a first pixel pairs for each reference image, where each of the first pixel pairs may include the first pixel and the third pixel corresponding to the first pixel and each of the second pixel pairs may include the first pixel and the second pixel corresponding to the first pixel; an operation of fusing similarities of the second pixel pairs; and an operation of determining the target reference image from among the reference images based on the fused similarity of the second pixel pairs for each reference image.

For example, a preset number of first pixel pairs may be determined in order starting from one with the highest similarity from among the first pixel pairs for each reference image. The preset number of second pixel pairs corresponding to the determined preset number of first pixel pairs may be determined. Each of the first pixel pairs may include the first pixel and the third pixel corresponding to the first pixel. Each of the second pixel pairs may include the first pixel and the second pixel corresponding to the first pixel. Here, a similarity between pixels may be calculated using cosine similarity but is not limited thereto.

For example, from among first pixel pairs of a mapping relationship map C_{(a,b)} for each reference image, a preset number (e.g., 50) of first pixel pairs may be determined in order of highest similarity. The preset number is not limited to the example described above but may be changed depending on an actual situation. For each reference image, a preset number of second pixel pairs corresponding to the preset number of first pixel pairs may be determined. For each reference image, the similarities of the preset number of second pixel pairs may be fused. For example, the similarities of the preset number of second pixel pairs may be fused by calculating a sum or weighted sum thereof. Based on the fused similarity of the second pixel pairs for each reference image, a target reference image may be determined from among a reference images. For example, the target reference image may be a reference image having the largest fused similarity of the second pixel pairs among the reference images.

According to an example embodiment, the operation of determining the pose of the target object based on the query image and the target reference image may include: an operation of generating a similarity matrix based on the first semantic feature of the query image and a second target semantic feature of the target reference image; an operation of optimizing the similarity matrix based on (i) first saliency information of the query image, (ii) second target saliency information of the target reference image, (iii) first geometric consistency information of the query image, and/or (iv) second target geometric consistency information of the target reference image; and an operation of determining the pose of the target object based on the optimized similarity matrix, the depth image corresponding to the query image, and a depth image corresponding to the target reference image.

The electronic device may extract the first semantic feature of the query image and the second target semantic feature of the target reference image, respectively, using the semantic feature extraction module. The electronic device may generate the similarity matrix of similarity between the first semantic feature of the query image and the second target semantic feature of the target reference image. For example, the similarity matrix may be generated based on a cosine similarity matrix but is not limited thereto.

For example, an initially optimized similarity matrix may be defined as expressed by Equation 17 below.

$$S = \frac{{f}_{r}^{′} * {f}_{q}^{′ T}}{‖ {f}_{r}^{′} ‖ ‖ {f}_{q}^{′} ‖} \qquad Equation 17$$

In Equation 17, fᵣ′ denotes a one-dimensional vector (length is hᵣwᵣ) corresponding to the second target semantic feature of the target reference image, f_{g}′ denotes a one-dimensional vector (length is h_{q}w_{q}) corresponding to the first semantic feature of the query image, ∥ ∥ denotes a length/magnitude of a calculated vector, and T denotes transpose.

According to an example embodiment, the electronic device may optimize the similarity matrix based on the first saliency information of the query image and the second target saliency information of the target reference image. For example, the electronic device may generate a saliency map of the query image and of each of the target reference images. The electronic device may calculate a weight under constraints on the saliency map of the query image and the saliency map of the target reference image. The electronic device may update the similarity matrix with the calculated weight. The electronic device may determine a weight of an optimal transport (OT) algorithm for the saliency maps using the OT algorithm and may optimize the similarity matrix based on the determined weight.

For example, for the OT algorithm, a total correlation may be defined as ΣᵢⱼTᵢⱼSᵢⱼ. Sᵢⱼ denotes an element in the similarity matrix to be optimized, and Tᵢⱼ denotes a matching of each pair of elements.

A global optimal matching may be expressed as T′ which may maximize the total correlation based on the saliency maps of the query image and the target reference image. T′ may be expressed by Equation 18 below.

$${T}^{*} = arg {min}_{T ∈ {R}^{{h}_{q} {w}_{q} \times {h}_{r} {w}_{r}}} {\sum }_{ij} {T}_{ij} ( 1 - {S}_{ij} ) \qquad Equation 18$$

$$s . t . T {1}_{{h}_{q} {w}_{q}} = {μ}_{r} ,$$

$$T {1}_{{h}_{r} {w}_{r}} = {μ}_{q}$$

In Equation 18, argmin represents calculating a variable T allowing ΣᵢⱼTᵢⱼ(1−Sᵢⱼ) to have a minimum value (i.e., obtain a maximum value of the total correlation) such that respective distributions in the row and column directions satisfy a distribution μᵣ determined by the saliency map of the target reference image and a distribution μ_{q} determined by the saliency map of the query image, respectively. For example, the process described above may be performed using a Sinkhorn algorithm but is not limited thereto.

According to an example embodiment, the electronic device may optimize the similarity matrix based on the first geometric consistency information of the query image and the second target geometric consistency information of the target reference image. That is, the consistency of the semantic features of the query image and the target reference image may improve the consistency of corresponding geometric shapes. For example, the process described above may optimize the similarity matrix by improving the geometric shapes using a Hough space voting algorithm.

In the Hough space voting algorithm, P_{q} denotes a position lattice corresponding to a feature map f_{q} of the query image, and Pᵣ denotes a position lattice corresponding to a feature map fᵣ of the target reference image. R_{q}=(f_{q}, P_{q}) and Rᵣ=(fᵣ, Pᵣ) denote two sets that combine features and positions. r denotes an element in the set R_{q}, and r′ denotes an element in the set Rᵣ. For ease of description, the two sets are expressed as D, i.e., D=(R_{q}, Rᵣ), and one matching is expressed as m, i.e., m=(r, r′). A matching confidence of m is expressed as p(m|D). The query image and the target reference image each includes a consistent object, and when it is assumed that the consistent object and a semantic portion are positioned in a Hough space X through an offset x, the matching confidence may be calculated as expressed by Equation 19 below.

$$p ( m \vert D ) = p ( {m}_{a} ) {\sum }_{x ∈ X} p ( {m}_{g} \vert x ) p ( x \vert D ) \qquad Equation 19$$

$$p ( m \vert D ) ∝ {\sum }_{m} p ( {m}_{a} ) p ( {m}_{g} \vert x )$$

In Equation 19, p(mₐ) denotes the similarity matrix and p(m_{g}|x) denotes a geometric matching probability corresponding to the offset x. The Hough space voting algorithm may improve the consistency of geometric shapes depending on the geometric matching probability.

According to an example embodiment, various methods may be used in combination to optimize the similarity matrix. For example, the electronic device may first optimize the similarity matrix using the saliency information and then optimize the similarity matrix using the geometric consistency information. For example, the electronic device may first optimize the similarity matrix using the geometric consistency information and then optimize the similarity matrix using the saliency information. For example, the electronic device may optimize the similarity matrix by executing the geometric consistency information and the saliency information in parallel. For example, the electronic device may optimize the similarity matrix using other methods in addition to the foregoing methods using the geometric consistency information and the saliency information.

According to an example embodiment, the electronic device may restore an initial pose of the query image based on the optimized similarity matrix, the depth image corresponding to the query image, and the depth image corresponding to the target reference image. For example, the electronic device may restore the initial pose of the query image through a YUSHE algorithm (e.g., a Umeyama algorithm).

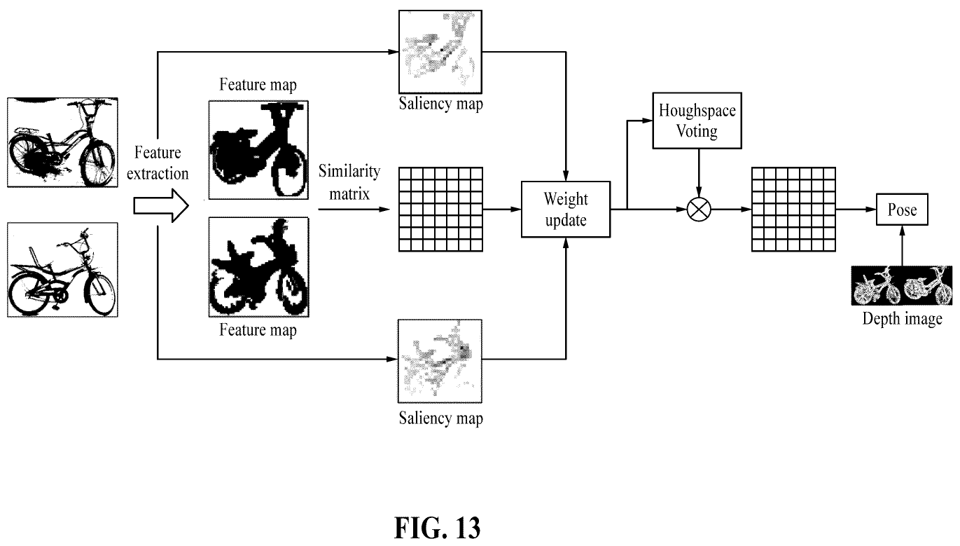

After determining the target reference image corresponding to the query image, the method of determining the pose of the target object may specifically include the following, as shown in FIG. 13.

The electronic device may generate a feature map and a saliency map of the query image and may generate a feature map and a saliency map of the target reference image.

The electronic device may calculate the similarity matrix based on the feature map of the query image and the feature map of the target reference image. For example, the electronic device may first optimize the similarity matrix through the OT algorithm based on the saliency map of the query image and the saliency map of the target reference image. Subsequently, the electronic device may generate geometric shape enhancement information for the first optimized similarity matrix through the Hough space voting algorithm, and perform optimization on the first optimized similarity matrix second time based on the geometric shape enhancement information to generate the second optimized similarity matrix. Subsequently, the electronic device may combine the second optimized similarity matrix with the depth image of the query image and the depth image of the target reference image and may then apply the Umeyama algorithm to the combined result to determine the pose of the target object in the query image.

According to an example embodiment, the electronic device may include at least one processor, and may optionally further include a transmitter/receiver and/or a memory connected to the at least one processor. The memory may store instructions for performing the operations described above to determine the pose of the target object in the query image. When executed by the at least one processor, individually or collectively, the instructions may cause the electronic device to perform the operations.

FIG. 11 illustrates an example configuration of an electronic device according to one or more example embodiments.

As shown in FIG. 11, an electronic device 4000 may include a processor 4001 and a memory 4003. The processor 4001 and the memory 4003 may be connected to each other via a bus 4002, for example. Optionally, the electronic device 4000 may further include a transmitter/receiver 4004, and the transmitter/receiver 4004 may be used to exchange data by transmitting and/or receiving the data to and/or from another electronic device. In practical applications, the transmitter/receiver 4004 is not limited to one, and the structure of the electronic device 4000 is not limited to the example embodiments described herein. Optionally, the electronic device 4000 may be a first network node, a second network node, or a third network node.

The processor 4001 may be, as non-limiting examples, a CPU, a general-purpose processor, a digital signal processor (DSP), an application-specific integrated circuit (ASIC), a field-programmable gate array (FPGA) or other programmable logic devices, a transistor logic device, a hardware component, or any combination thereof. The processor 4001 may implement or execute various example logic blocks, modules, and circuits. For example, the processor 4001 may be a combination for realizing computing functionality, including a combination of one or more microprocessors, a combination of a DSP and a microprocessor, or the like.

The bus 4002 may include a path for transferring information between the components described above. The bus 4002 may be a peripheral component interconnect (PCI) bus or an extended industry standard architecture (EISA) bus. The bus 4002 may be classified into an address bus, a data bus, a control bus, or the like. For illustrative purposes, only one bold line is shown in FIG. 11, but there is not necessarily only one bus or only one type of bus.

The memory 4003 may be, as non-limiting examples, a read-only memory (ROM) or other types of static storage devices capable of storing static information and instructions, a random-access memory (RAM) or other types of dynamic storage devices capable of storing information and instructions, an electrically erasable programmable read-only memory (EEPROM), a compact disc read-only memory (CD-ROM), or other optical disc storage (e.g., a compressed optical disc, a laser disc, an optical disc, a digital versatile disc, a Blu-ray disc, etc.), a disk storage medium, other magnetic storage devices, or other media that may be used to carry or store a computer program and be read by a computer.

The memory 4003 may be used to store computer programs or instructions for executing various example embodiments described herein, and the computer programs or instructions may be controlled and executed by the processor 4001. The processor 4001 may execute a computer program stored in the memory 4003 to realize the various example embodiments described herein and cause the electronic device 4000 to perform the operations and methods described herein according to the example embodiments.

The computing apparatuses, the electronic devices, the processors, the memories, the image sensors, the vehicle/operation function hardware, the displays, the information output system and hardware, the storage devices, and other apparatuses, devices, units, modules, and components described herein with respect to FIGS. 1-13 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method performed by an electronic device, comprising:
obtaining a query image;
obtaining reference images corresponding to the query image, wherein the reference images are obtained based on having respective reference objects therein that have a same object type as an object type of an object in the query image;
determining a first semantic feature and first information corresponding to the query image, wherein the first information comprises first geometric information of the query image or first positional information of the query image;
determining second semantic features and second pieces of information of the respectively corresponding reference images, wherein the second pieces of information each comprise second geometric information or second positional information of their respectively corresponding reference images, each reference image having a corresponding second semantic feature and second piece of information; and
determining a pose of the target object based on (i) the first semantic feature and the first information and (ii) the second semantic features and the second pieces of information.

2. The method of claim 1, wherein the determining of the pose of the target object comprises:
generating a first association feature of the query image based on the first semantic feature and the first geometric information of the query image;
generating a second association feature of the query image based on the second semantic features and the second pieces of geometric information of the reference images; and
determining the pose of the target object based on the first association feature and the second association feature.

3. The method of claim 1, wherein the obtaining of the reference images corresponding to the query image comprises:
based on determining that the target object in the query image is an object registered in a database, obtaining the reference images from the database.

4. The method of claim 2, wherein the determining of the pose of the target object based on the first association feature and the second association feature comprises:
generating correlation matrixes of correlation between the query image and each of the respectively corresponding reference images based on the first association feature and the second association feature, wherein each correlation matrix represents a relative position of a first pixel block of the query image with respect to a positionally-corresponding second pixel block of its corresponding reference image; and
determining the pose of the target object based on the correlation matrixes.

5. The method of claim 4, wherein the generating of one of the correlation matrixes comprises:
inputting the first association feature and the second association feature corresponding to the one of the correlation matrixes into an attention network.

6. The method of claim 5, wherein the attention network comprises a first attention module,
wherein the first attention module comprises two first self-attention units connected in parallel, a first cross-attention unit, and two second self-attention units connected in parallel,
wherein the generating of the correlation matrixes comprises:
generating a first self-correlation feature of the query image and a second self-correlation feature of each of the reference images by inputting the first association feature and the second association feature into the first self-attention units, respectively;
generating a first cross-correlation feature of the query image and a second cross-correlation feature of each of the reference images by inputting the first self-correlation feature and the second self-correlation feature into the first cross-attention unit;
generating a third self-correlation feature of the query image and a fourth self-correlation feature of each of the reference images by inputting the first cross-correlation feature and the second cross-correlation feature into the second self-attention units, respectively; and
generating the correlation matrix between the query image and each of the reference images based on the third self-correlation feature and the fourth self-correlation feature.

7. The method of claim 6, wherein the attention network further comprises one or more second attention modules,
wherein each of the one or more second attention modules comprises a second cross-attention unit and two third self-attention units connected in parallel,
wherein an input of a second attention module is a self-correlation feature generated by a previous second attention module, and a self-correlation feature generated by the second attention module is used as an input to a next second attention module,
wherein the generating of the correlation matrix between the query image and each of the reference images comprises:
generating the correlation matrixes between the query image and the respective reference images based on a self-correlation feature generated by a last second attention module.

8. The method of claim 6, wherein the generating of the first self-correlation feature of the query image and the second self-correlation feature of each of the reference images by inputting the first association feature and the second association feature into the first self-attention units comprises:
generating a first feature vector by stitching feature vectors respectively corresponding to pixel blocks of the first association feature;
generating a first semantic slot sequence corresponding to the first feature vector;
generating a second semantic slot sequence by applying a self-attention mechanism to the first semantic slot sequence; and
generating the first self-correlation feature based on the second semantic slot sequence and the first feature vector.

9. The method of claim 8, wherein the generating of the first self-correlation feature based on the second semantic slot sequence and the first feature vector comprises:
for each semantic slot of the second semantic slot sequence, generating a processed semantic slot by expanding a semantic slot into the same number of pixel blocks as the first association feature;
generating a semantic slot feature vector having the same feature dimension as the first feature vector by decoding the processed semantic slot based on positional information;
generating a second feature vector by fusing feature vectors of pixel blocks at the same position among semantic slot feature vectors;
generating a fused feature vector by fusing the first feature vector and a feature vector of a pixel block at the same position in the second feature vector; and
generating the first self-correlation feature by applying the self-attention mechanism to the fused feature vector.

10. The method of claim 6, wherein the generating of the first cross-correlation feature of the query image and the second cross-correlation features of the respective reference images by inputting the first self-correlation feature and the second self-correlation features into the first cross-attention unit comprises:
generating a third feature vector by stitching feature vectors respectively corresponding to pixel blocks of the first self-correlation feature;
generating a fourth feature vector by stitching feature vectors respectively corresponding to pixel blocks of the second self-correlation feature;
generating a third semantic slot sequence corresponding to the third feature vector and a fourth semantic slot sequence corresponding to the fourth feature vector, respectively;
generating a fifth semantic slot sequence corresponding to the third semantic slot sequence and a sixth semantic slot sequence corresponding to the fourth semantic slot sequence by applying a cross-attention mechanism to the third semantic slot sequence and the fourth semantic slot sequence, respectively; and
generating the first cross-correlation feature and the second cross-correlation feature based on the fifth semantic slot sequence, the sixth semantic slot sequence, the third feature vector, and the fourth feature vector.

11. The method of claim 1, wherein the determining of the pose of the target object comprises:
selecting a target reference image from among the reference images based on a semantic feature corresponding to the query image, semantic features corresponding to each of the respective reference images, and similarity information associated with positional information between the query image and each of the reference images; and
determining the pose of the target object based on the query image and the target reference image.

12. The method of claim 11, wherein the determining of the target reference image from among the reference images comprises:
for a first reference image of the reference images, determining a second pixel of the first reference image that is most similar to a first pixel of the query image from among pixels of the first reference image corresponding to a first position range with respect to the first pixel of the query image, based on the semantic feature of the query image and a semantic feature of the first reference image;
for the first reference image, determining a third pixel of the first reference image that is most similar to the second pixel of the first reference image from among pixels of the query image corresponding to a second position range with respect to the second pixel of the first reference image, based on the semantic feature of the query image and the semantic feature of the first reference image; and
determining the target reference image from among the reference images based on the first pixel, the second pixel, and the third pixel.

13. The method of claim 12, wherein the determining of the target reference image from among the reference images based on the first pixel, the second pixel, and the third pixel comprises:
for each reference image, determining a preset number of second pixel pairs from among first pixel pairs for a corresponding reference image, in order of similarity, wherein each of the first pixel pairs comprises the first pixel and the third pixel corresponding to the first pixel, and each of the second pixel pairs comprises the first pixel and the second pixel corresponding to the first pixel;
fusing similarities of the second pixel pairs; and
determining the target reference image from among the reference images, based on the fused similarity of the second pixel pairs for each reference image.

14. The method of claim 11, wherein the determining of the pose of the target object based on the query image and the target reference image comprises:
generating a similarity matrix based on the first semantic feature of the query image and a second target semantic feature of the target reference image;
optimizing the similarity matrix based on first saliency information of the query image, second target saliency information of the target reference image, first geometric consistency information of the query image, or second target geometric consistency information of the target reference image; and
determining the pose of the target object based on the optimized similarity matrix, a depth image corresponding to the query image, and a target depth image corresponding to the target reference image.

15. A non-transitory computer-readable storage medium storing instructions that, when executed by a processor, cause the processor to perform the method of claim 1.

16. An electronic device, comprising:
one or more processors; and
a memory storing instructions configured to cause the one or more processors to:
obtain a query image;
obtain reference images corresponding to the query image, wherein the reference images are obtained based on having respective reference objects therein that have a same object type as an object type in the query image;
determine a first semantic feature and first information corresponding to the query image, wherein the first information comprises first geometric information of the query image or first positional information of the query image;
determine second semantic features and second pieces of information of the respectively corresponding reference images, wherein the second pieces of information each comprise second geometric information or second positional information of their respectively corresponding reference images, each reference image having a corresponding second semantic feature and second piece of information; and
determine a pose of the target object based on (i) the first semantic feature and the first information and (ii) the second semantic features and the second pieces of information.

17. The electronic device of claim 16, wherein the instructions are further configured to cause the electronic device to:
generate a first association feature of the query image based on the first semantic feature and the first geometric information of the query image;
generate a second association feature of the query image based on the second semantic feature and the second pieces of geometric information of the reference images; and
determine the pose of the target object based on the first association feature and the second association feature.

18. The electronic device of claim 16, wherein the instructions are further configured to cause the one or more processors to:
based on determining that the target object in the query image is not registered in a database, obtain, as the reference images, images of the target object having respective poses through an image acquisition device.

19. The electronic device of claim 16, wherein the instructions are further configured to cause the one or more processors to:
generate correlation matrixes of correlation between the query image and each of the respectively corresponding reference images based on the first association feature and the second association feature, wherein each correlation matrix represents a relative position of a first pixel block of the query image with respect to a positionally-corresponding second pixel block its corresponding reference image; and
determine the pose of the target object based on the correlation matrixes.

20. The electronic device of claim 16, wherein the instructions are further configured to cause the one or more processors to:
select a target reference image from among the reference images based on a semantic feature corresponding to the query image, a semantic feature corresponding to each of the reference images, and similarity information associated with positional information between the query image and each of the reference images; and
determine the pose of the target object based on the query image and the target reference image.
